(19) United States
(12) Patent Application Publication
(10) Pub. No.: US 2009/0187960 A1
(43) Pub. Date: Jul. 23, 2009

(54) IPTV receiving system and data processing method

(76) Inventors: Joon Hui Lee, Seoul (KR); Jong Yeul Suh, Seoul (KR); Jae Hyung Song, Seoul (KR)

Correspondence Address: MCKENNA LONG & ALDRIDGE LLP, 1900 K STREET, NW, WASHINGTON, DC, 20006, US

(21) Appl. No.: 12/320,128

(22) Filed: Jan. 16, 2009

Related U.S. Application Data
(60) Provisional application No. 61/021,880, filed on Jan. 17, 2008.

(51) Int. Cl. H04N 7/173

(52) U.S. Cl. 725/131; 375/E07.078

(57) ABSTRACT

An internet protocol television (IPTV) receiving system and a method of processing data are disclosed. The IPTV receiving system according to present invention comprises a signal receiving unit for receiving an IPTV signal including respective scalable video streams for IPTV services of a plurality of layers including a base layer and at least one enhancement layer, the respective scalable video streams of the plurality of layers having different identifiers and program table information for the scalable video streams, a demodulating unit for demodulating the respective scalable video streams of the plurality of layers and the program table information of the received IPTV signal, a demultiplexer for identifying and outputting the demodulated video stream of the base layer with reference to the demodulated program table information and identifying and outputting the demodulated video stream of at least one enhancement layer, and a decoder for performing video decoding on a video stream of at least one layer identified and outputted by the demultiplexer.

This application claims the benefit of U.S. Provisional Application No. 61/021,880, filed on Jan. 17, 2008, which is hereby incorporated by reference as if fully set forth herein.

### BACKGROUND OF THE INVENTION

1. Field of the Invention

The present invention relates to an IPTV receiving system, and more particularly, to an IPTV receiving system and a data processing method.

2. Discussion of the Related Art

Conventional TV services are provided such that a cable, terrestrial, or satellite broadcast provider transmits content created by a broadcaster through a radio communication medium such as a broadcast network and users view the broadcast content using a TV receiver that can receive signals of the communication medium.

As digital TV technologies have been developed and commercialized, it has become possible to provide a variety of content such as real-time broadcasts, Content on Demand (CoD), games, and news to viewers not only using the existing radio medium but also using the Internet connected to each residence.

One example of provision of content using the Internet is an Internet Protocol TV (IPTV) service. The IPTV service provides an information service, moving image content, broadcasts, etc., to a television using high-speed Internet.

While the IPTV service is similar to general cable broadcasting or satellite broadcasting in that it provides broadcast content such as video content, the IPTV service is characterized in that it also supports bidirectional communication. The IPTV service also allows users to view a desired program at a desired time, unlike general terrestrial broadcasting, cable broadcasting, or satellite broadcasting.

### SUMMARY OF THE INVENTION

Accordingly, the present invention is directed to an IPTV receiving system and a data processing method that substantially obviate one or more problems due to limitations and disadvantages of the related art.

An object of the present invention is to provide an IPTV receiving system and a data processing method that are necessary to provide scalable video services according to bitrate changes and codec profile/level.

Another object of the present invention is to provide an IPTV receiving system and a data processing method that can enhance the receiving performance of the receiving system by performing additional encoding on IPTV service data and by transmitting the processed data to the receiving system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written-description and claims hereof as well as the appended drawings.

To achieve these objects and other advantages and in accordance with the purpose of the invention, as embodied and broadly described herein, a receiving system includes a signal receiving unit, a demodulating unit, a demultiplexer, and a decoder. The signal receiving unit receives an IPTV signal including respective scalable video streams for IPTV services of a plurality of layers including a base layer and at least one enhancement layer, the respective scalable video streams of the plurality of layers having different identifiers and program table information for the scalable video streams. The demodulating unit demodulates the respective scalable video streams of the plurality of layers and the program table information of the received IPTV signal. The demultiplexer identifies and outputs the demodulated video stream of the base layer with reference to the demodulated program table information and identifying and outputting the demodulated video stream of at least one enhancement layer. And, the decoder performs video decoding on a video stream of at least one layer identified and outputted by the demultiplexer.

In another aspect of the present invention, A data processing method for an internet protocol television (IPTV) receiving system includes receiving an IPTV signal including respective scalable video streams for IPTV services of a plurality of layers including a base layer and at least one enhancement layer, the respective scalable video streams of the plurality of layers having different identifiers and program table information for the scalable video streams, demodulating the respective scalable video streams of the plurality of layers and the program table information of the received IPTV signal, identifying and outputting a demodulated video stream of the base layer with reference to the demodulated program table information and identifying and outputting a demodulated video stream of at least one enhancement layer, and performing video decoding on the identified and output video stream of at least one layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a configuration of an IPTV system for providing IPTV services;

FIG. 2 schematically illustrates a multicast scheme;

FIG. 3 schematically illustrates a unicast scheme;

FIG. 4 is a structural diagram of NAL unit for transporting video data or header information.

FIG. 5 is a schematic block diagram of a scalable coding system to which scalable video coding scheme is applied.

FIGS. 6 and 7 are a diagram for temporal scalable video coding according to an embodiment of the present invention.

FIG. 8 is a block diagram of an apparatus for decoding a temporal scalable video stream according to an embodiment of the present invention.

FIG. 9 is a schematic block diagram of a video decoder according to the present invention.

FIG. 10 is a diagram for spatial scalable video coding according to an embodiment of the present invention.

FIG. 11 is a diagram to explain interlayer intra-prediction.

FIG. 12 is a diagram for explaining interlayer residual prediction.

FIG. 13 is a diagram to explain interlayer motion prediction.

FIG. 14 is a flowchart of decoding of syntax elements for interlayer prediction.

FIG. 15 is a diagram to explain SNR scalable video coding according to an embodiment of the present invention.

FIG. 16 is a diagram for SNR scalability coding using residual refinement according to one embodiment of the present invention.

FIG. 17 is an overall flowchart of a scalable video decoder.

FIG. 18 is a flowchart of a decoding process for SNR scalable bitstream.

FIG. 19 is a flowchart for a decoding process for a spatial scalable bitstream.

FIG. 20 is a flowchart for a decoding process for enhanced layer data.

FIG. 21 illustrates a VCT syntax according to an embodiment of the present invention.

FIG. 22 illustrates an embodiment of a method for transmitting data of each layer of scalable video according to the present invention.

FIG. 23 illustrates an embodiment in which the receiving system receives and processes scalable video data transmitted with a different PID allocated to each layer.

FIG. 24 is a block diagram illustrating an embodiment of a method in which the demultiplexer 2301 of FIG. 23 processes scalable video data of each layer using a VCT among the PSI/PSIP information.

FIG. 25 illustrates an embodiment of a bitstream syntax structure of a scalable_service_location_descriptor according to the present invention.

FIG. 26 illustrates example values that can be allocated to the stream_type field according to the present invention and example definitions of the values.

FIG. 27 illustrates example values that can be allocated to the scalability_type field according to the present invention and example definitions of the values.

FIG. 28 illustrates example values that can be allocated to the frame_rate_code field according to the present invention and example definitions of the values.

FIG. 29 illustrates example values that can be allocated to the profile_idc field according to the present invention and example definitions of the values.

FIG. 30 illustrates example values that can be allocated to the level_idc field according to the present invention and example definitions of the values.

FIG. 31 is a flow chart illustrating an embodiment of a method in which the demultiplexer 2301 of FIG. 75 processes scalable video data of each layer using a VCT among the PSI/PSIP information.

FIG. 32 illustrates a PMT syntax according to an embodiment of the present invention.

FIG. 33 is a block diagram illustrating an embodiment of a method in which the demultiplexer 2301 of FIG. 75 processes scalable video data of each layer using a PMT among the program table information such as PSI/PSIP information.

FIG. 34 illustrates an embodiment of a bitstream syntax structure of a scalable_video_descriptor according to the present invention.

FIG. 35 is a flow chart illustrating an embodiment of a method in which the demultiplexer 2301 of FIG. 23 processes scalable video data of each layer using a PMT among the PSI/PSIP information.

FIG. 36 is a block diagram of an IPTV receiver according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

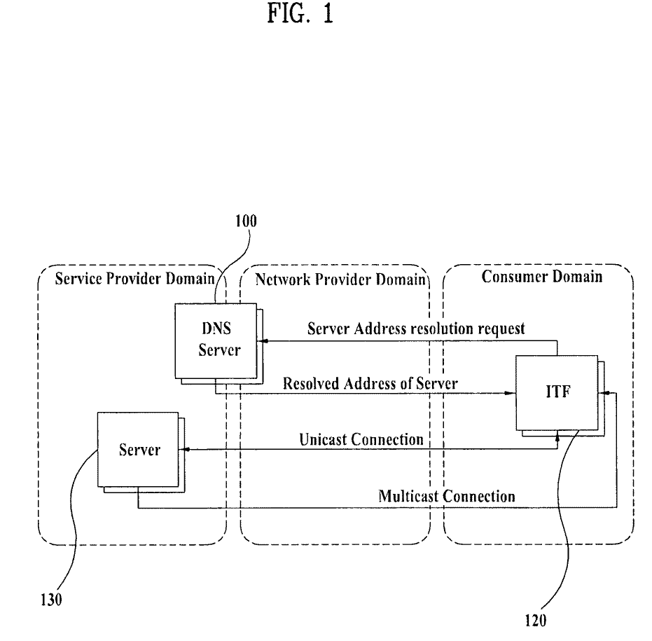

FIG. 1 illustrates a configuration of an IPTV system for providing IPTV services.

As shown in FIG. 1, the IPTV system includes a service provider domain, a network provider domain, and a customer domain.

The service provider domain may include a content provider and a service provider. The content provider serves to provide content to the service provider. The service provider serves to provide services to subscribers, and collects a variety of content and converts content signals according to an IP environment and transfers the converted signals to users (or customers). The service provider also transmits multimedia data and performs maintenance, repair, and management of a transmission network to enable users to reliably receive content and provides functions and facilities to enable the content provider to transmit data over the network. Here, the service provider may be a virtual entity and the content provider may also serve as the service provider.

The network provider domain serves to connect users and the service provider through an IP network. The transmission system may use a variety of networks such as an access network, a backbone network, or a wireless Wide Area Network (WAN).

The customer domain is a domain which consumes IPTV services. The customer domain serves to reproduce data received using facilities such as xDSL or cable or to immediately reply to a request made by a user. The customer domain mostly includes companies which produce IPTV-related devices, the types of which can be divided into IPTVs, IP STBs, IP phones, etc. In the customer domain, a customer domain apparatus may be used to receive and display a broadcast containing content provided by the content provider. Examples of the customer domain apparatus include a set-top box, a PC, a mobile terminal, an IPTV Terminal Function (ITF) device, or a Delivery Network Gateway (DNG) device.

The following is a more detailed description of each of the domains.

The content provider may be a TV station or a radio station that produces broadcast programs. The TV station is a conventional terrestrial or cable broadcast station. The broadcast station produces and stores programs that can be viewed by users and can convert the programs to digital signals for transmission. The purpose of converting programs into digital signals is to enable transmission of various types of broadcasts.

The radio station is a general radio broadcast station and is operated without video channels in most cases although it may provide video channels in some cases. Video on Demand (VoD) and Audio on Demand (AoD) services have different characteristics from those of the TV station or the radio station. The content provider generally provides live broadcast programs such that users cannot rewind or pause and view the programs unless they record the programs. However, in the case of VoD or AoD services, the service provider stores broadcast program or movies or music and then provides them to users such that the users can reproduce and view desired broadcast programs or movies or music when they desire to view. For example, when a customer cannot view a broadcast program due to lack of time, they can, at a later time, access a site that provides such a broadcast service and download or immediately reproduce a corresponding file. Similarly, when a customer cannot listen to an audio program due to lack of time, they can, at a later time, access a site that provides such an audio service and download or immediately reproduce a corresponding file. Music on Demand (MoD) services allows customers to download and listen to desired music. Music companies or distributors can provide such MoD services by extending existing web services.

Reference will now be made to embodiments of services provided by the content provider.

A PF service can be provided by a company that manages all broadcast information and location information provided by the content provider. This service mainly contains broadcast time information of a corresponding broadcast station or location information required for broadcasting and information which enables users (or customers) to access the broadcast station. Customers can obtain and display such information on the screen. The PF service should be provided by each broadcast station. In IPTV environments, the PF service is provided to allow customers to access the corresponding broadcast station.

The EPG service is a convenient service that allows customers to check broadcast programs for each time zone and for each channel. A program that provides the EPG service is previously installed automatically on a customer device so that it is executed when requested. While the customer can obtain information of the corresponding broadcast station from the PF service, they can use the EPG service more conveniently since they can collectively obtain information of real-time broadcast channels of all broadcast stations using the EPG service. For example, since the IPTV has useful functions, for example a function to schedule recording of a program such as CNN news and a function to schedule viewing of a broadcast such as a Disney broadcast, the EPG service should provide detailed information of broadcast programs of a corresponding region for each time zone. Certain drama-related EPG is designed to allow search of the contents of the drama and to allow classification of programs into categories such as science fiction, drama, and animation. The EPG may also contain detailed information of story or characters of a drama or movie of a simple broadcast program. One major challenge of the EPG service is how to transmit EPG data suitable for the customer since there are a lot of types of customer licenses for IPTV viewing. To access the EPG service, the customer only needs to locate and press an input key on a remote controller.

An Electronic Content Guide (ECG) service provides a variety of functions that allow the customer to easily use information regarding a variety of content provided by the content provider, the location of a corresponding access server, the authority to access the server, etc. That is, the ECG service has a function to allow the customer to easily access servers that store a variety of content and serves as an EPG that provides detailed information of the content. The ECG provides integrated information of services such as AoD, MoD, and VoD rather than real-time broadcasts, similar to the EPG to reduce the burden of the customer having to individually access a content service to view or download content. Although the ECG service is similar to the EPG service, the ECG does not provide real-time broadcast channel information but instead allows the customer to view, download, and store content at any time since the content is stored in the server. To access a server that contains each desired content item, the customer needs to enter an address, which it is very difficult to type, and to access PF servers. This is a very complicated procedure requiring a lot of time. A company that provides the ECG allows the ECG program to be automatically installed on the customer device and collects information of all content items and provides corresponding data. Similar to the EPG service, to access the ECG service, the customer only needs to click a corresponding input key on the remote controller.

A portal service is a web service provided by each broadcast station and a portal server that provides such a portal service is connected to a web server of a company that provides content services. The portal service allows the customer to search or view a list of programs provided by each broadcast station or by content providers that provide content services. The functions of the portal service are similar to those of the ECG or EPG. However, since the portal service also provides functions associated with user authentication or license contract, it is necessary for the customer to access the portal service to view a desired program. While the ECG or EPG service provides an integrated broadcast or content list, the portal service provides information of a list of content or broadcasts provided by a corresponding program provider, thereby enabling detailed search. To access the portal service, the customer only needs to click a portal input key on the remote controller.

Equipment of the content provider needs to have functions to provide such services. To allow these functions to operate normally, a server 130 of each service company should already be connected to the IP network so that it can transmit a corresponding program in real time or transmit broadcast information. Each broadcast station or service company should be equipped with a system that is connected to the network of the service provider to enable transmission of multimedia data without errors or delay using a real-time Internet protocol such as RTP, RTSP, RSVP, or MPLS. For example, to transmit the multimedia data created according to the MPEG-2 and AC-3 audio specification from a TV studio that currently provides news data, the corresponding server needs to transcode the multimedia data into an IPTV format. After this process, an RTP/UDP protocol including time information is attached to the multimedia data to implement a caption or overdub feature and the multimedia data is then transmitted through the IP network provided by the service provider.

The service provider provides the bandwidth and the stability of the network to allow satisfactory transmission of multimedia data and/or broadcast data received from the content provider. Service providers may provide IPTV services using the existing cable network. In this case, it is necessary to change equipment of the delivery network. That is, it is necessary to construct equipment that can perform real-time data transmission and to construct a network for the customer in consideration of the bandwidth. Such equipment should use a multicast service, which is a basic network service of the IPTV, to process a large amount of multimedia data in order to reduce the bandwidth. When the bandwidth is not secured, the service provider may re-transcode multimedia broadcast data received from the content provider or the optical cable network and reconstruct the data into an MPEG-4 or MPEG-7 format for transmission. To accomplish this, the service provider should provide some services which mainly include a Network Management System (NMS) service, a Dynamic Host Control Protocol (DHCP) service, and a CDN service.

The NMS service provides a function to manage the delivery network over which the service provider can transmit data to each customer (or user) and a Remote Configuration and Management Server (RCMS) function. That is, when the customer cannot receive a broadcast since a problem has occurred in the transmission network, the service provider should have means for immediately solving the problem. The NMS is widely used as a standardized means for smoothly controlling and managing remote transport layer machines. Using this service, it is possible to determine how much traffic has occurred for a broadcast and an area where the bandwidth is insufficient. Also, the service provider should provide content providers with the NMS service to allow the content providers to generate and manage multicast groups when providing a multicast service. This is because the service provider may need to be able to further generate a multicast group in some cases.

The DHCP service is used to automatically allocate an IP address to the IPTV receiver of the customer and to inform the IPTV receiver of the address of the CDN server. The DHCP service is also used as an appropriate means for allocating an IP address to a PC in a general network. That is, it is necessary to transmit an available address to an IPTV receiver that is authorized to use the server to allow the customer to perform a registration procedure when initially accessing the server. Generally, an IPTV receiver which supports IPv4 also supports IPv6. Thus, an IPTV receiver which supports IPv4 can also be used.

The CDN service is provided as data that the service provider provides to the IPTV receiver. When the IPTV receiver is powered on to start operation, the IPTV receiver receives CDN information from the service provider while receiving IP information through the DHCP service. The CDN information contains information associated with user registration or authentication performed by the IPTV service provider and PF information described above. By acquiring the CDN information from the service provider, the IPTV receiver can receive an IP broadcast signal.

The customer may have various types of IPTV receivers. If the customer has a general TV receiver, the customer may rent an IPTV STB to enjoy an IPTV broadcasting service at a low cost. The customer may also apply for an IP phone at a low service cost while the service provider pays the additional service fee. The IPTV receiver basically includes a network interface that can access the network and an Internet protocol to receive and process data packets received from the network. When the data is multimedia data, the IPTV receiver reproduces the data on the screen. Here, when the customer has issued a request by operating the remote controller, the IPTV receiver immediately transmits a corresponding data packet to the server through the network to receive corresponding information from the server. That is, the IPTV receiver can operate to transmit a request from the customer to the server while processing received multimedia data in a bidirectional fashion. A variety of IPTV buttons may also be provided on the IPTV receiver to allow the customer to fully use the service. Using the IPTV receiver, the customer can store and view key scenes in a drama and can receive additional services such as hotel reservation or location information services.

On the other hand, the NMS that has been described above provides not only the function to allow the service provider to manage the network but also an RCMS function. The RCMS function helps the customer to control and manage their IPTV receiver. The importance of the RCMS will increase as the use of IPTV receivers increase and the number of additional relevant services increases. Thus, the SNMP protocol has been compulsorily employed in IPTV broadcast receivers in order to allow the service provider to manage and control IPTV broadcast receivers. This will enable the IPTV broadcast receiver to acquire statistical data of a protocol currently used for communication and information of a currently used processor and to identify the TV manufacturer.

To receive an IPTV service, an ITF 120 in the customer domain can transmit a server address resolution request to a DNS server 110. The DNS server 110 then transmits a server address to the ITF 120. Using the received address, the ITF 120 connects to the server 130 to receive an IPTV service. Here, the ITF 120 can connect to the server 130 using at least one of a multicast scheme and a unicast scheme.

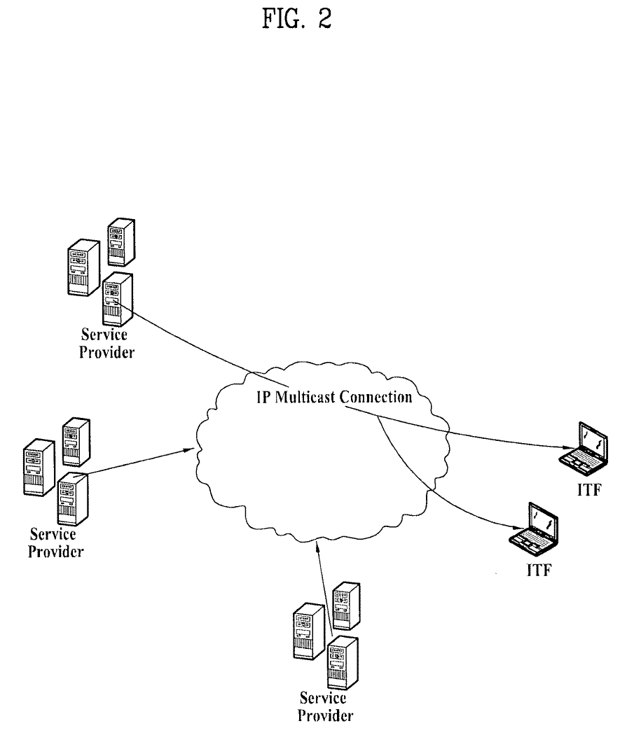

FIG. 2 schematically illustrates the multicast scheme.

As shown in FIG. 2, the multicast scheme is a method in which data is transmitted to a number of receivers in a specific group. For example, the service provider can collectively transmit data to a number of registered ITFs. An Internet Group Management Protocol (IGMP) protocol can be used for the multicast registration.

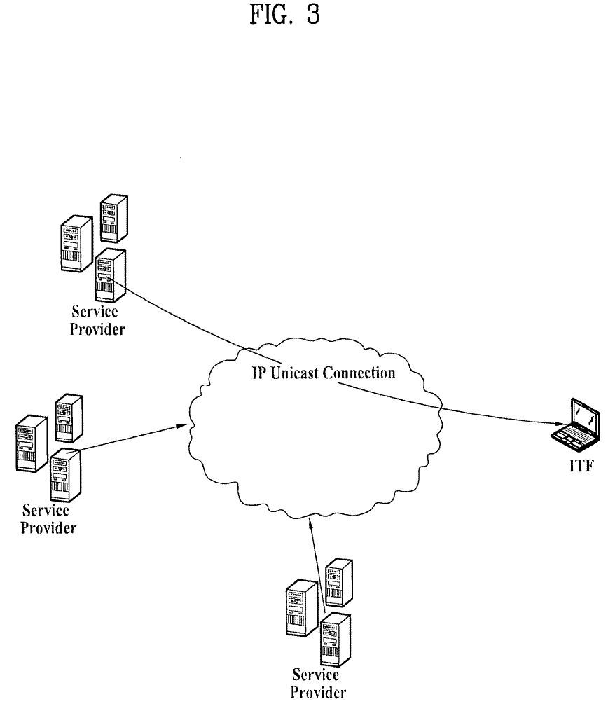

FIG. 3 schematically illustrates the unicast scheme.

As shown in FIG. 3, the unicast scheme is a method in which one transmitter transmits data to one receiver in a one to one manner. For example, in the case of the unicast scheme, when an ITF has requested a service from the service provider, the service provider transmits a corresponding service to the ITF in response to the request.

Scalable Video Service

As for the present invention, taking into consideration variable receiver's specifications and variable bitrate environments according to network bandwidth for IPTV services, it is necessary to provide scalable video services according to bitrate changes and codec profile/level.

To accomplish this, the present invention aims to allow a scalable video service to be supported in IPTV environments and to allow channel setting to be efficiently performed and an IPTV service to be efficiently provided when a scalable video service is provided.

Particularly, the present invention aims to enable a demultiplexer to select data of each layer when processing scalable video data for use in an IPTV service, thereby reducing the amount of calculation performed by the video decoder.

One scalable bitstream may include two or more dependent layers. In this case, a scalable codec includes a base layer and a plurality of enhancement layers. Herein, information of the base layer and information of consecutive enhancement layers are used together to create an improved video bitstream. For example, according to image-quality-related scalability, it is possible to create, from a bitstream, a bitstream that has the same spatial and temporal dimensions as those of the bitstream but has a different image quality therefrom. Generally, the base layer provides a preset image quality and each of the consecutive enhancement layers is encoded to provide an image quality higher than that of video created from base layers. Similarly, the same principle is applied to temporal and spatial resolution to support scalability.

A scalable video coding (SVC) scheme encodes a video signal with a best image quality and enables an image presentation by decoding to use a partial sequence (i.e., a sequence of frame intermittently selected from a whole sequence) of a picture sequence generated from the best image quality encoding. In a transmitting system for an IPTV service of the present invention, the scheme can be applied in a manner of inserting a video signal data corresponding to a different partial sequence in each of areas. Thus, the scalable video coding scheme is the technology for compression coding of video signal data and considers spatial redundancy, temporal redundancy, scalable redundancy and inter-view redundancy.

Considering the above facts, VCL (video coding layer) data, which are coded with such consideration, can be mapped by NAL (network abstraction layer) unit before they are transmitted or stored. In this case, the NAL means the unit for mapping video data or header information to bitstream of system for transmission, storage and the like.

Therefore, each NAL unit can contain video data or header information. Video signal mapped by the NAL unit can be transmitted or stored via packet based network or bitstream transport link. In order to decode the video signal mapped by the NAL unit, it is able to performing parsing by the NAL unit.

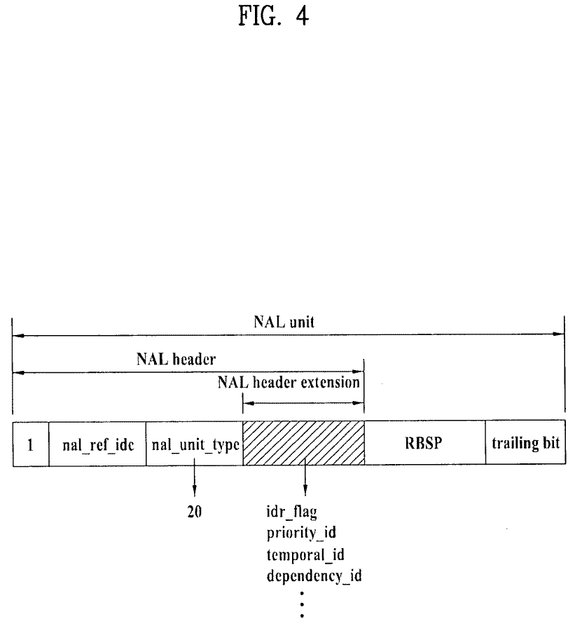

FIG. 4 is a structural diagram of NAL unit for transporting video data or header information.

Referring to FIG. 4, NAL unit basically includes two parts of a NAL header and RBSP (raw byte sequence payloads). The NAL header contains flag information (nal_ref_idc) indicating whether a slice becoming a reference picture of the NAL unit is included and an identifier (nal_unit_type) indicating a type of the NAL unit. Compressed original data is stored in the RBSP. And, RBSP trailing bits are added to a last portion of the RBSP to represent a length of the RBSL as a multiplication of 8 bits.

Types of the NAL unit include IDR (instantaneous decoding refresh) picture, SPS (sequence parameter set), PPS (picture parameter set), SEI (supplement enhancement information) and the like. Moreover, it is able indicate a scalable-video-coded or multi-view-video coded slice as the NAL unit. For instance, if a NAL unit type (nal_unit_type) is 20, it can be observed that a current NAL is not an IDR picture but a scalable video coded slice or a multi-view video coded slice.

Generally, at least one or more sequence parameter sets and at least one or more picture parameter sets are transmitted to a decoder before a slice header and slice data are decoded. In this case, the sequence parameter set means the header information containing such information related to coding of overall sequence as profile, level and the like. Therefore, the sequence parameter set RBSP and the picture parameter set RBSP play a role as header information on result data of moving picture compression. In this case, various kinds of configuration information can be contained in a NAL header area or an extension area of the NAL header.

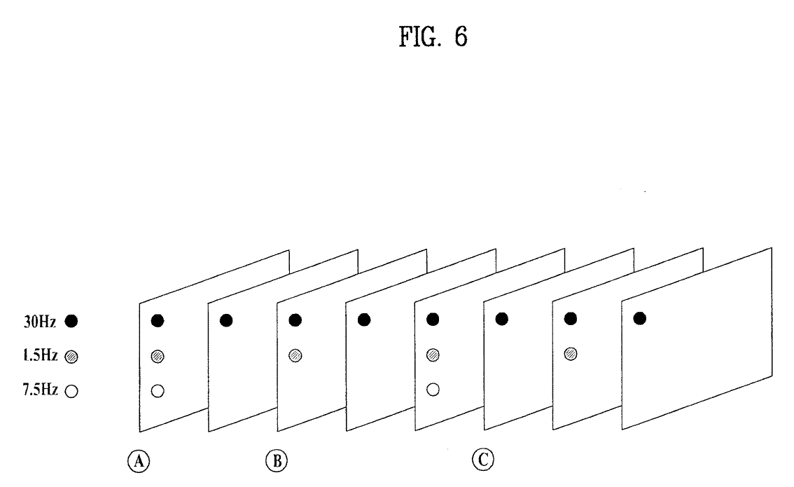

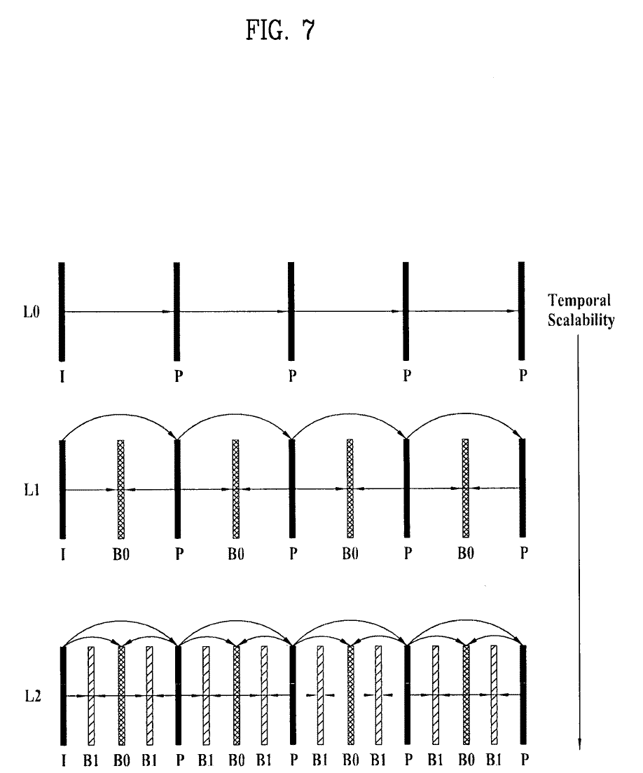

For instance, since SVC (scalable video coding) or MVC (multi-view video coding) is an additional technique for AVC technique, addition of various kinds of configuration information for a corresponding bitstream only is more efficient than unconditional addition. For instance, it is able to add flag information capable of identifying whether it is MVC or SVC coding in the header area of NAL or the extension area of the NAL header. Only if the inputted bitstream is the MVC or SVC bitstream according to the flag information, it is able to add configuration information on each sequence. For instance, in case of the SVC bitstream, it is able to add such configuration information as information indicating whether it is IDR picture, priority information, temporal level information, dependency information of NAL, quality level information, information indicating whether inter-layer prediction was used, and the like. In this case, the temporal level information can be represented using a syntax element temporal_id. The temporal level information indicates a temporal level of a current picture. In predicting a picture B added in an enhanced layer, the temporal level information is usable. This will be explained in detail with reference to FIGS. 6 and 7 later.

In this case, as mentioned in the foregoing description, a scalable-coded picture sequence enables a sequence presentation of low image quality by receiving and processing a partial sequence of the encoded picture sequence. Yet, if a bit rate is lowered, the image quality is considerably lowered. To solve this problem, it is able to provide a separate supplementary picture sequence for a low data rate, e.g., a picture sequence having a small picture and/or a low per-sec frame number, etc. Such a supplementary sequence is called a base layer, while a main picture sequence is called an enhanced or enhancement layer.

In applying the present invention to a transmitting system for an IPTV service, a video stream corresponding to base layer is inserted in the area A/B, and a video stream corresponding to the enhanced layer can be inserted in the area C. According to another embodiment, if the layer is divided into three parts, it is able to insert video streams corresponding to each of the three parts in the areas A, B and C, respectively.

Moreover, in the specifications, requirements for various profiles and levels are set to enable implementation of a target product with an appropriate cost. In this case, a decoder should meet the requirements decided according the corresponding profile and level. Thus, two concepts, profile_idc and level_idc are defined to indicate a function or parameter for representing how far the decoder can cope with a range of a compressed sequence. The profile means that technical elements required for algorithm in a coding process are specified. In particular, the profile is a set o technical elements required for decoding a bitstream and can be called a sort of sub-specification. Meanwhile, the level defines how far the technical element specified by the profile will be supported. In particular, the level plays a role in defining capability of a decoder and complexity of a bitstream.

Profile identifier (profile_idc) can identify that a bit stream is based on a prescribed profile. The profile identifier means a flag indicating a profile on which a bit stream is based. For instance, in H.264/AVC, if a profile identifier is ‘66’, it means that a bit stream is based on a baseline profile. If a profile identifier is ‘77’, it means that a bit stream is based on a main profile. If a profile identifier is ‘88’, it means that a bit stream is based on an extended profile.

The base line profile is able to support intra-coding or inter-coding using ‘I’ slice and ‘P’ slice or entropy coding that uses context adaptive variable length code. Applied fields of the baseline profile can include video call, video conference, wireless communication and the like.

The main profile is able to support interlace scan video, inter-coding using ‘B’ slice, inter-coding using weighted prediction and entropy coding using context based binary arithmetic coding. Applied fields of the main profile can include TV broadcasting, video storage and the like.

And, the extended profile is able to support a use of SP slice or SI slice, data partitioning for error recovery and the like. Applied fields the extended profile can include streaming media and the like. Each of the above profiles has flexibility for sufficiently supporting its wide range of applied fields. And, it is understood that they may be applicable to other fields as well as the above examples for the applied fields.

The profile identifier can be included in the sequence parameter set. Therefore, it is necessary to identify that an inputted bitstream is related to a prescribed file. For instance, if the inputted bitstream is identified as the profile for MVC or SVC, it is able to add a syntax to enable at least one additional information to be transmitted. As mentioned in the above description, if a prescribed type of a bitstream is identified, a decoder decodes the bitstream by a scheme suitable for the identified type. Based on the above concept, the scalable video system is explained in detail as follows.

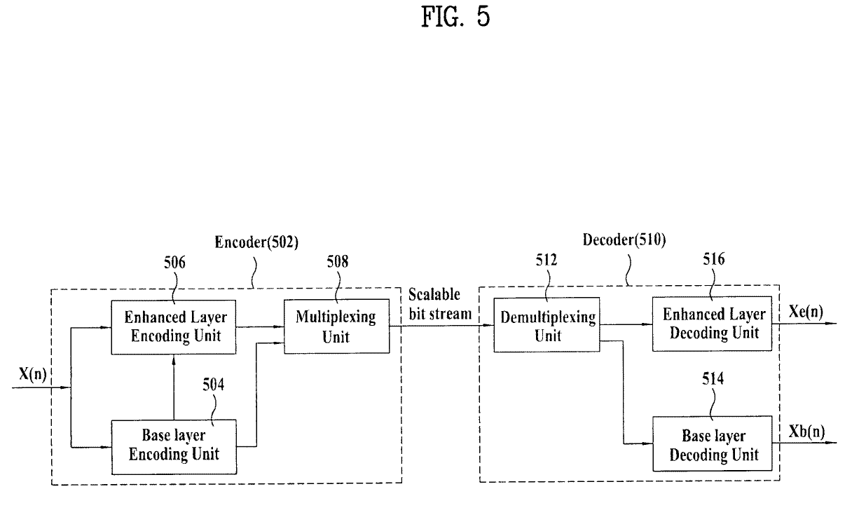

FIG. 5 is a schematic block diagram of a scalable coding system to which scalable video coding scheme is applied.

Scalable video coding scheme is explained in brief with reference to FIG. 5 as follows. First of all, a base layer encoder 504 of an encoder 502 generates a base bitstream by compressing an inputted video signal X(n). An enhanced layer encoder 506 generates an enhanced layer bitstream using the inputted video signal X(n) and information generated by the base layer encoder 504. And, a multiplexing unit 508 generates a scalable bitstream using the base layer bitstream and the enhanced layer bitstream.

The generated scalable bitstream is transported to a decoder 510 via prescribed channel. The transported scalable bitstream is divided into the enhanced layer bitstream and the base layer bitstream by a demultiplexing unit 512.

A base layer decoding unit 514 is able to decode an output video signal Xb(n) by receiving the base layer bitstream, and an enhanced layer decoding unit 516 is able to decode an output video signal Xe(n) by receiving the enhanced layer bitstream. In this case, the output video signal Xb(n) may be a video signal having an image quality or resolution lower than that of the output video signal Xe(n).

Moreover, it is able to discriminate whether the scalable bitstream transported from the decoder 510 is a base layer bit stream or an enhanced layer bitstream according to type information (nal_unit_type) of NAL. In case of the enhanced layer bitstream, as mentioned in the foregoing description of FIG. 4, it is able decode the enhanced layer bitstream using syntax elements in the extension area of the NAL header. For instance, using priority information (priority_id), dependency information (dependency_id) of NAL, quality level information (quality_id) and the like, it is able to know whether the enhanced layer bitstream is a spatial enhanced layer bitstream or an SNR enhanced layer bitstream. If it is confirmed as the enhanced layer bitstream, decoding is performed by the enhanced layer decoder 7416.

In this case, in the scalable video signal decoding/encoding scheme, more efficient coding is enabled if a prediction signal is generated using inter-layer correlation. Moreover, it is able to apply various tools supportable by H.264 to the scalable video signal decoding/encoding scheme.

On the contrary, if the transported scalable bitstream is confirmed as the base layer bitstream according to the NAL unit type (nal_unit_type), it can be decoded by the base layer decoder 514. For instance, the base layer decoder 514 can include H.264 decoder. And, the base layer bitstream can be decoded by H.264 decoding process. Therefore, prior to explaining spatial scalability and SNR scalability of the scalable video coding schemes, the decoding process of H.264 scheme is explained in brief with reference to FIG. 7 as follows.

FIGS. 6 and 7 are a diagram for temporal scalable video coding according to an embodiment of the present invention.

First of all, temporal scalability can determine a layer of video by a frame rate. In FIGS. 6 and 7, three scalable layers are taken as examples.

Referring to FIGS. 6 and 7, it becomes a higher temporal scalable layer toward a bottom from a top, which means that a frame rate gets higher. Temporal scalable video coding can be implemented by applying a concept of a hierarchical B picture or a hierarchical P picture to H.264 video coding. In particular, a video layer does not request an additional bitstream syntax to represent scalability. The concept of the hierarchical B picture or the hierarchical P picture is explained as follows.

First of all, in predicting a picture B added to an enhanced layer, a reference picture for inter-prediction of a corresponding picture is limited to picture belonging to a layer including a current picture or a lower layer. For instance, assuming that a temporal level of a prescribed layer is set to L, in predicting a picture belonging to the temporal level L, it is unable to use a picture corresponding to a temporal level greater than the temporal level L as a reference picture. In other words, temporal level information of a reference picture used for decoding a current slice is unable to have a value greater than temporal level information of the current slice. And, in an inter-prediction process, a current picture is unable to refer to a picture in a layer higher than a layer of the current picture, and is able to refer to only a picture in a layer equal to or lower than the layer of the current picture.

Thus, a picture corresponding to a prescribed temporal layer is independently decodable regardless of a decoding of a picture in a temporal layer higher than the prescribed temporal layer. Therefore, if a decodable level is determined according to capability of a decoder, it is able to decode H.264-compatible video signal by a corresponding frame rate.

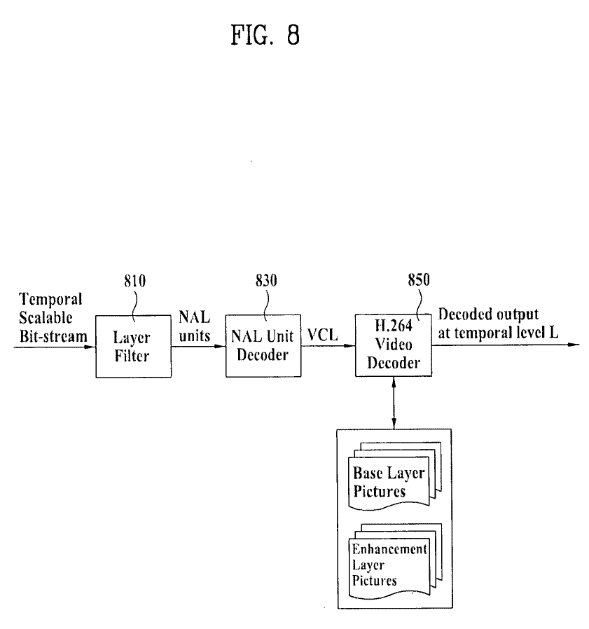

FIG. 8 is a block diagram of an apparatus for decoding a temporal scalable video stream according to an embodiment of the present invention.

Referring to FIG. 8, the decoding apparatus includes a layer filter unit 810, a NAL unit decoding unit 830, and a video decoding unit 850.

The layer filter unit 810 filters an inputted scalable video coded NAL stream using a maximum value of a temporal layer decodable by the decoding apparatus based on capability of the decoding apparatus. In this case, assuming that a maximum value (Tmax) indicating a temporal level is named temporal level information (temporal_id) corresponding to a maximum frame rate decodable by the video decoding unit 850, the layer filter unit 810 does not output a NAL unit that the temporal level information (temporal_id) has a value greater than the maximum value (Tmax). Hence, the video decoding unit 850 receives data from the NAL unit decoding unit 830 until a temporal layer corresponding to the maximum frame rate, which is outputtable based on the capability of the video decoding unit 850, and then decodes the received data.

Moreover, the video decoding unit 850 does not need discrimination by a temporal layer in a decoding process. In particular, it is not necessary to perform a decoding process by discriminating data corresponding to a base layer and data belonging to an enhanced layer from each other. This is because the data inputted to the video decoding unit 850 is decoded through the same process of the decoding process of the video decoding unit without layer discrimination. For instance, if the video decoding unit 850 includes H.264 video decoder, even if a temporal scalable video coded bitstream is received, decoding will be performed according to H.264 decoding process. Yet, if an inputted bitstream is a spatial scalable video coded bitstream or an SNR scalable video coded bitstream, the H.264 video decoder will perform decoding for a base layer only.

The decoding process of the H.264 video decoder is explained as follows.

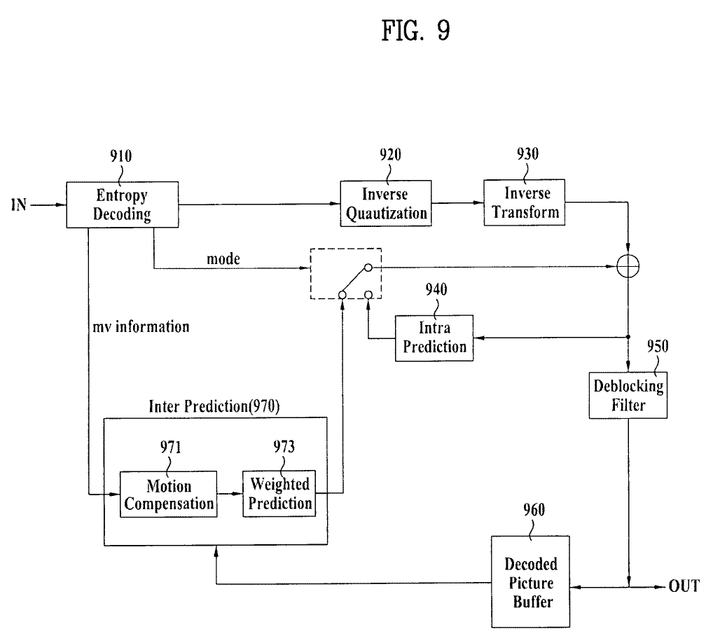

FIG. 9 is a schematic block diagram of a video decoder according to the present invention.

Referring to FIG. 9, a video decoder according to the present invention includes an entropy decoding unit 910, an inverse quantization unit 920, an inverse transform unit 930, an intra-prediction unit 940, a deblocking filter unit 950, a decoded picture buffer unit 960, an inter-prediction unit 970 and the like. And, the inter-prediction unit 970 includes a motion compensation unit 971, a weighted prediction unit 973 and the like.

First of all, in order to decode a received video sequence, parsing is performed by NAL unit. The parsed bitstream is entropy-decoded by the entropy decoding unit 910 and a coefficient of each macroblock, a motion vector and the like are extracted. The inverse quantization unit 920 obtains a coefficient value converted by multiplying a received quantized value by a predetermined constant, and the inverse transform unit 930 reconstructs a pixel value by inverse-transforming the coefficient value. And, the intra-prediction unit 940 performs inter-picture prediction from a decoded sample within a current picture using the reconstructed pixel value.

Meanwhile, the deblocking filter unit 950 is applied to each coded macroblock to reduce block distortion. A filter smoothens a block edge to enhance an image quality of a decoded frame. Selection of a filtering process depends on boundary strength and gradient of an image sample around a boundary. Pictures through filtering are outputted or stored in the decoded picture buffer unit 960 to be used as reference pictures.

The decoded picture buffer unit 960 plays a role in storing or opening the previously coded pictures to perform inter-picture prediction. In this case, to store the pictures in the decoded picture buffer unit 960 or to open the pictures, a frame number of each picture and a POC (picture order count) are usable.

Pictures referred to for coding of a current picture are stored and a list of reference pictures for inter-picture prediction is constructed. And, reference pictures are managed to realize inter-picture prediction more flexibly. For instance, a memory management control operation method and a sliding window method are usable. This is to manage a reference picture memory and a non-reference picture memory by unifying the memories into one memory and realize efficient memory management with a small memory. And, the reference pictures managed in the above manners can be used by the inter-prediction unit 970.

The inter-prediction unit 970 performs inter-picture prediction using the reference pictures stored in the decoded picture buffer unit 960. The inter-picture prediction coded macroblock can be divided into macroblock partitions. Each of the macroblock partitions can be predicted from one or two reference pictures. A target picture is predicted by using a reference picture and reconstructed by using the predicted picture. In case of that, temporal level information of the reference picture is unable to have a value greater than that of the target picture.

And, the inter-prediction unit 970 can include a motion compensation unit 971, a weighted prediction unit 973 and the like.

The motion compensation unit 971 compensates a current block for motion using informations transported from the entropy decoding unit 910. The motion compensation unit 971 extracts motion vectors of blocks neighbor to the current block and then obtains a motion vector predicted value of the current block. The motion compensation unit 971 compensates the current block for a motion of the current block using the obtained motion vector predicted value and a difference value extracted from the video signal. In this case, the motion compensation can be performed using a single reference picture or a plurality of pictures. And, a motion compensation in the best efficiency may be performed by raising a pixel precision. For example, the macroblock partition corresponding to one of 16×16 macroblock, 16×8 macroblock, 8×16 macroblock, 8×8 macroblock, 8×4 macroblock and 4×4 macroblock, may be used as a block size for performing the motion compensation.

The weighted prediction unit 973 is used to compensate a phenomenon that an image quality of a sequence is considerably degraded in coding the sequence of which brightness varies according to time. For instance, the weighted prediction can be classified into an explicit weighted prediction method and an implicit weighted prediction method.

In the explicit weighted prediction method, there is a case of using a single reference picture or a case of using a pair of reference pictures. In case of using a single reference picture, a prediction signal is generated from applying a prediction signal corresponding to motion compensation by a weighted coefficient. In case of using a pair of reference pictures, a prediction signal is generated from adding an offset value to a value resulting from multiplying a prediction signal corresponding to motion compensation by a weighted coefficient.

In the implicit weighted prediction method, weighted prediction is performed using a distance from a reference picture. In order to find the distance from the reference picture, it is able to use POC (picture order count) that is a value indicating an output order of picture.

As mentioned in the above description, a prescribed scheme is selected for the pictures decoded through intra-prediction or inter-prediction according to mode information outputted from the entropy decoding unit 910. And, the pictures can be displayed through the deblocking filter unit 950.

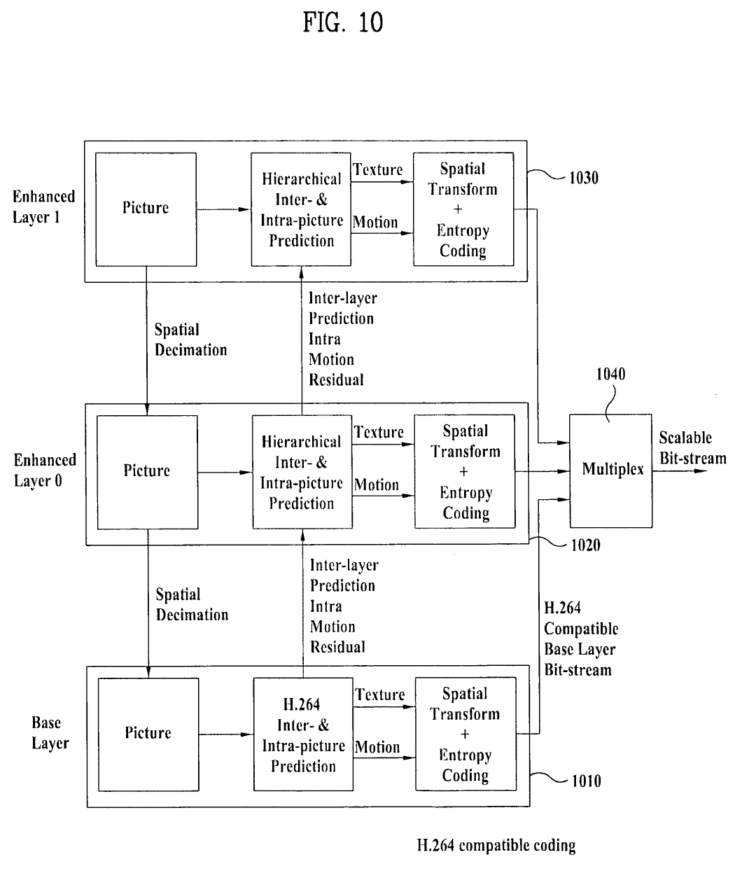

FIG. 10 is a diagram for spatial scalable video coding according to an embodiment of the present invention.

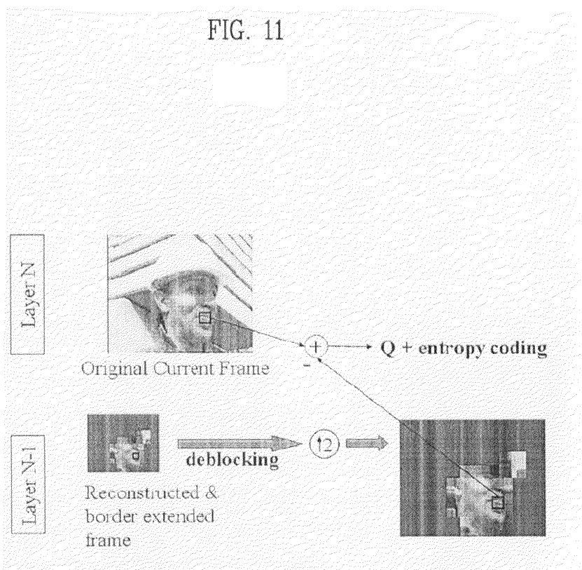

First of all, spatial scalability and SNR scalability can be implemented with a multi-layer structure. In the multi-layer structure, a sequence of resolution differing for each layer should be coded to provide a sequence of specific resolution. In this case, in order to remove inter-layer redundancy from each spatial layer, it is able to use a signal of spatial resolution lower than that of a currently coded layer as a prediction signal by upsampling the former signal with the spatial resolution of the currently coded layer. Thus, by coding a residual signal, from which redundancy between a current signal and a predicted signal is removed, by inter-layer prediction, it is able to provide spatial scalability. The inter-layer prediction can be performed on intra-texture, residual signal and motion information. This will be explained in detail with reference to FIGS. 11 to 13 later.

FIG. 10 schematically shows a spatial scalable encoding system that includes a base layer coding unit 1010, an enhance layer 0 coding unit 1020, an enhanced layer 1 coding unit 1030 and a multiplexing unit 1040.

The spatial scalability is a coding scheme for giving a difference of picture size (resolution) by each layer unit. And, the picture size gradually increases toward an upper layer. Therefore, the picture size increases toward the enhanced layer 1 coding unit 1030 from the base layer coding unit 1010.

The base layer coding unit 1010 performs coding on a picture having lowest spatial resolution. The base layer coding unit 1010 should use coding scheme compatible with conventional coding scheme. For instance, in case of using H.264 coding scheme, it will be compatible with H.264 decoder. Through the base layer coding unit 1010, it is able to output a bitstream coded by H.264 scheme.

The enhanced layer 0 coding unit 1020 is able to perform interlayer prediction by referring to a picture in the base layer. In this case, interlayer intra-prediction, inter-layer residual prediction or interlayer motion prediction can be performed. Likewise, the enhanced layer 1 coding unit 1030 is able to perform interlayer prediction by referring to a picture in the enhanced layer 0. The above-predicted informations are transported to the multiplexing unit 1040 through transformation and entropy coding.

And, the multiplexing unit 1040 is able to generate a scalable bitstream from the entropy-coded informations.

In the following description, the interlayer predicting methods, i.e., interlayer intra-prediction, interlayer residual prediction and interlayer motion prediction will be explained in detail. And, if they are explained in aspect of encoding, they can be inferred in aspect of decoding in the same manner.

FIG. 11 is a diagram to explain interlayer intra-prediction.

Referring to FIG. 11, in case that a block of a lower layer Layer N−1 corresponding to a macroblock to be encoded on a current layer Layer N is encoded in an intra-prediction mode, it can be used as a predicted signal by reconstructing the block of the corresponding lower layer and upsampling the reconstructed block with spatial resolution of the macroblock. For instance, the block of the corresponding lower layer may be the co-located block of a base layer.

Subsequently, a residual layer, which is a difference between the predicted signal and the current macroblock is obtained. The residual signal is then encoded through quantization and entropy process. In this case, a deblocking filter is applicable after reconstruction to eliminate a block effect within the block of the lower layer or between neighbor intra-blocks.

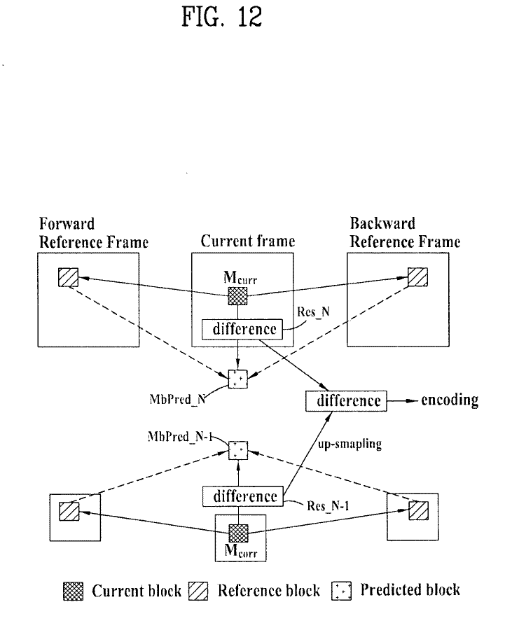

FIG. 12 is a diagram for explaining interlayer residual prediction.

Referring to FIG. 12, if a block of a lower layer corresponding to a macroblock to be encoded is encoded in an inter-picture prediction mode and includes a residual signal, it is able to perform interlayer prediction on the residual signal. If motion information of a current block is equal or similar to motion information of a corresponding block of a lower layer, it is able to raise encoding efficiency by removing interlayer redundant information when an encoded residual signal of the lower layer is upsampled and then used as a predicted signal of a current block.

Yet, if there is a big difference between motion information of a current block and motion information of a lower layer, blocks of the lower layer referred to in encoding blocks of the lower layer may be located different from blocks of a current layer referred to in encoding a current block. In this case, since interlayer redundant information barely exists, there may be no interlayer prediction effect. Therefore, interlayer prediction of a residual signal can be adaptively performed according to motion information.

When motion information of a current macroblock is equal or similar to that of a corresponding block of a lower layer, an interlayer prediction process using a residual signal is explained with reference to FIG. 12 as follows.

First of all, a predicted signal (MbPred_N) is generated using a forward reference frame and a backward reference frame for a current macroblock (Mcurr) of a current layer (Layer N). Subsequently, a residual signal (Res_N), which is a difference value between the current block and the predicted signal, is generated.

Likewise, a predicted signal (MbPred_N−1) is generated using a forward reference frame and a backward reference frame for a macroblock (Mcorr) of a lower layer (Layer N−1) corresponding to the current macroblock. Subsequently, a residual signal (res_N−1), which is a difference value between the macroblock of the corresponding lower layer and the prediction signal (MbPred_N−1), is generated and then upsampled.

Subsequently, a difference value between the residual signal (Res_N) of the current macroblock and the signal generated from upsampling the residual signal (Res_N−1) of the corresponding lower layer is found and then encoded. In this case, the upsampling of the residual signal can be performed according to a spatial resolution ratio. And, a bi-linear filter is usable as the upsampling filter.

FIG. 13 is a diagram to explain interlayer motion prediction.

Referring to FIG. 13, an enhanced layer (spatial layer N+1) has a size in horizontal and vertical directions twice bigger than that of a base layer (spatial layer N) by spatial scalability. In this case, if a macroblock of an enhanced layer is coded in an inter-prediction mode by interlayer prediction, a case that partitioning information of the corresponding macroblock is inferred from a base layer is shown in (a) of FIG. 13. If partitioning information of a co-located macroblock in the base layer is 8×8, a current block has a size of 16×16. If the partitioning information of the base layer is N×M, macroblock partitioning information in an enhanced layer is determined as 2N×2M. Moreover, in case that a motion estimation mode of a macroblock in a base layer is a direct mode or 16×16, partitioning information of 16×16 is applied to four macroblocks in a corresponding enhanced layer.

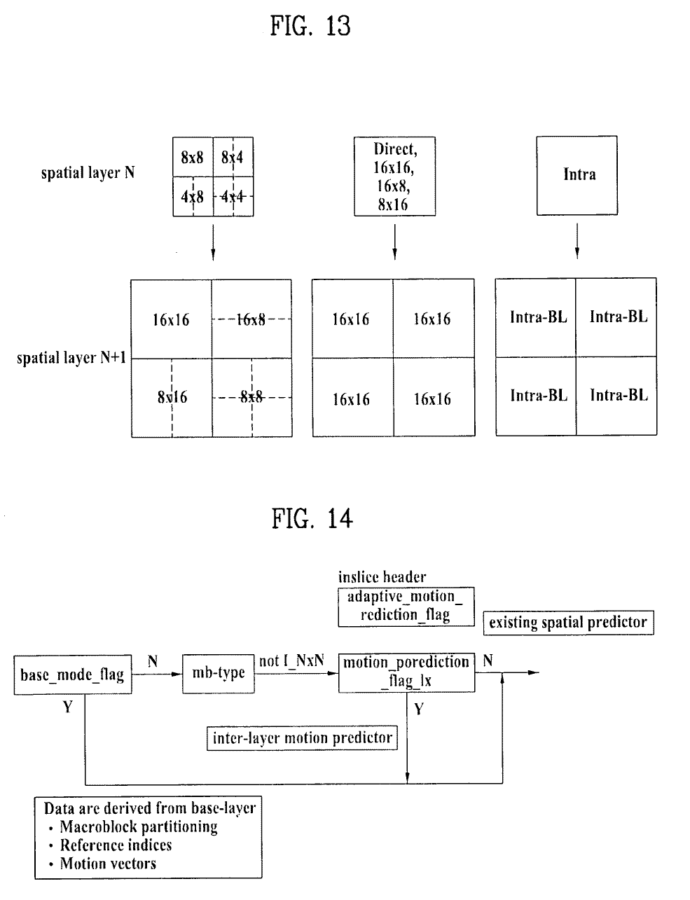

FIG. 14 is a flowchart of decoding of syntax elements for interlayer prediction.

Referring to FIG. 14, base_mode_flag is read to find out whether information on a current macroblock or a block is inferred.

If the base_mode_flag is ‘1’, partitioning information and reference information of a macroblock, a motion vector and the like are inferred from a corresponding block in a base layer. If the base_mode_flag is ‘0’, it is determined whether the inference is performed in addition using mb_type. If the macroblock is not intra-coded, i.e., if the macroblock is inter-coded, a presence or non-presence of execution of interlayer motion prediction is decided using motion_prediction_flag_10 and motion_prediction_flag_11. In particular, a presence or non-presence of inference from a base layer is decided for list 0 and list 1 each. In this case, adaptive_motion_prediction_flag should be set to ‘1’ by slice unit. If motion_prediction_flag is ‘0’, reference information and partitioning information are coded. And, decoding is performed using a conventional motion vector decoding method.

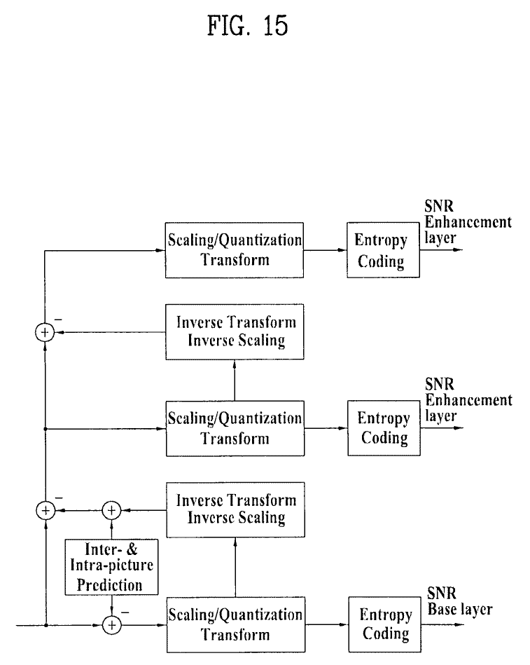

FIG. 15 is a diagram to explain SNR scalable video coding according to an embodiment of the present invention.

First of all, SNR scalability is a coding scheme for giving gradual enhancement of image quality by each layer unit and an be handled as a special case of spatial scalability that a base layer and an enhanced layer are equal to each other in a picture size. This may be called coarse-grain scalability. And, the same scheme of the aforesaid interlayer prediction of the spatial scalability is applicable. Yet, the corresponding upsampling process may not be used. And, residual prediction is directly performed in a transformation domain.

When the interlayer prediction is used in the coarse-grain scalability, refinement of texture information can be performed in a manner of quantization using a value smaller than a quantization step size used for a previous CGS layer. Thus, the quantization step size value gets smaller toward an upper layer and a better image quality can be provided.

Yet, the number of generally supported rate points is equal to the number of layers. Switching between different CGS layers is possible at a predetermined point of bitstream only. Besides, as a relative rate difference between consecutive CGS layers gets smaller, efficiency of a multi-layer structure becomes reduced.

Therefore, various rates and various CGS accesses may be necessary. This is called medium-grain scalability. The difference from the VGS is that coding scheme on an adjusted high level is used. For instance, the medium-grain scalability enables switching between different MGS layers is possible at a random point within a bitstream.

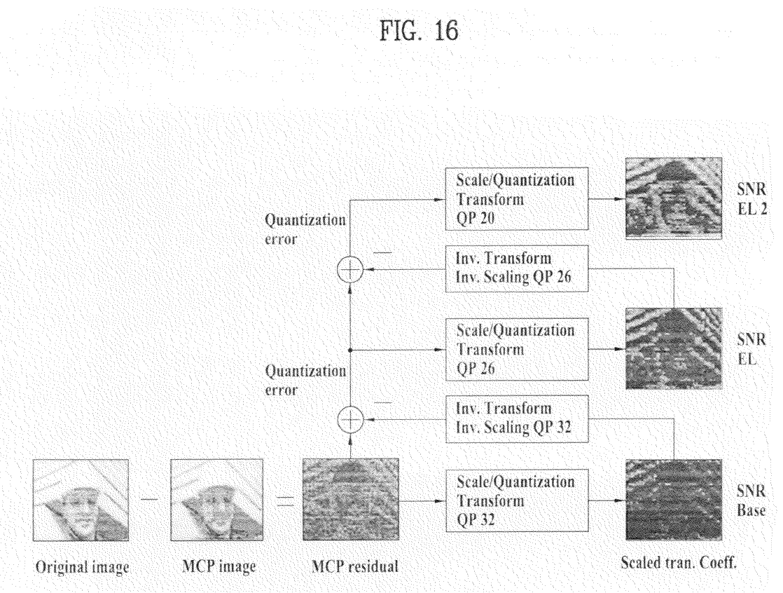

FIG. 15 shows SNR scalability coding using residual refinement by layer unit according to one embodiment of the present invention. Referring to FIG. 15, all layers have pictures of the same resolution. In this case, intra-prediction can be performed in SNR base layer only. By performing coding on quantization error between an original residual signal and a reconstructed residual signal of a lower layer, it is able to perform refinement on the residual signal. Its detailed example is explained with reference to FIG. 16 as follows.

FIG. 16 is a diagram for SNR scalability coding using residual refinement according to one embodiment of the present invention.

Referring to FIG. 16, according to one embodiment of the present invention, a first residual image is obtained from an original image and a motion-compensated predicted image. Quantization with QP=32 and transformation are sequentially performed on the first residual. A second residual image is then obtained by performing inverse transform and dequantization on the scaled coefficients values. Assuming that a difference value between the first and second residual images is a third residual image, the third residual image becomes quantization error.

The above process is repeated on the third residual image. In this case, it is able to a QP value smaller than the former QP value (=‘32’) used for the SNR base layer. For instance, it is able use ‘26’ as the QP value for SNR enhanced layer 1. And, it is able to use 20, which is smaller than ‘26’, as the QP value for SNR enhanced layer 2. Through this process, it is able to obtain a better quality of image.

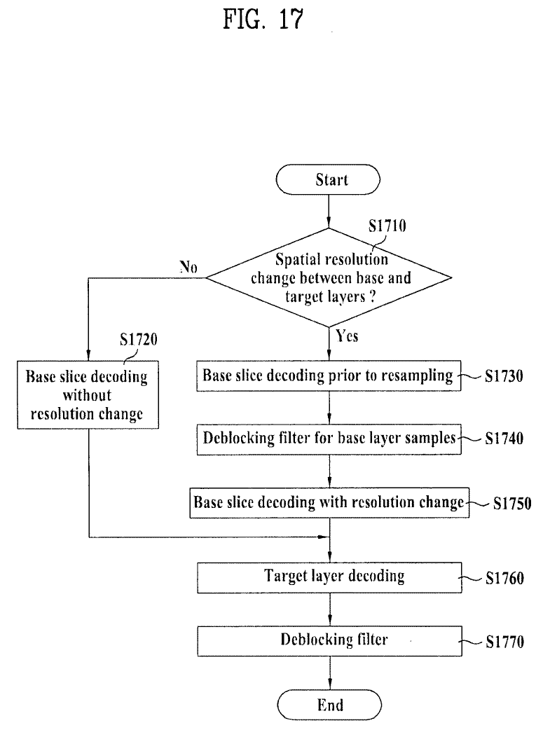

FIG. 17 is an overall flowchart of a scalable video decoder.

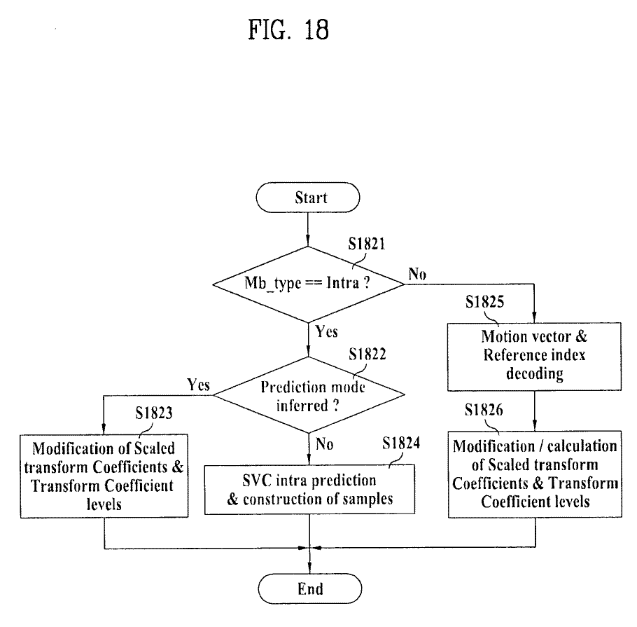

Referring to FIG. 17, it is checked whether a change of spatial resolution exists between a base layer and a target layer [S1710]. If there is no changed of the spatial resolution, decoding is performed on a slice of the base layer [S1720]. In particular, decoding is performed on SNR scalable bitstream. This will be explained in detail with reference to FIG. 18 later.

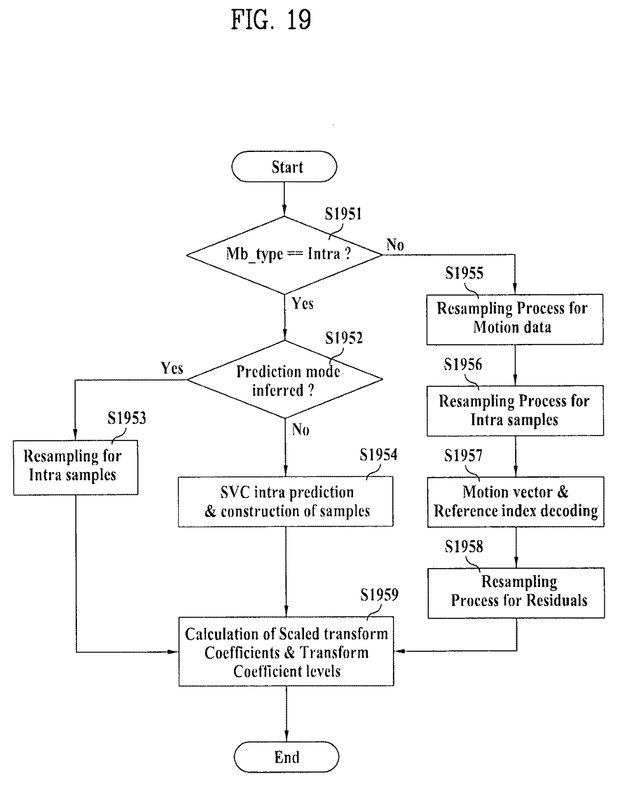

Yet, as a result of the checking step, if there exists the change of the spatial resolution between the base and target layers, decoding is performed on the slice of the base layer prior to re-sampling. In particular, deblocking filtering is performed on samples of the base layer [S1740] and decoding is then performed on the slice of the base layer [S1750]. Namely, decoding is performed on a spatial scalable bitstream. This will be explained in detail with reference to FIG. 19 later.

After completion of the decoding of the base layer, decoding is then performed on enhanced layer data [S1760] This will be explained in detail with reference to FIG. 86 later.

After the decoding has been performed on the base and enhanced layers, an image is outputted through deblocking filtering [S1770].

FIG. 18 is a flowchart of a decoding process for SNR scalable bitstream.

Referring to FIG. 18, it is checked whether a type (mb_type) of macroblock to be currently coded is intra-prediction [S1801]. If the type of the current macroblock is the intra-prediction, it is checked whether a prediction mode for the current macroblock or a block is inferred [S1802].

If the prediction mode is inferred, scaled transform coefficients and transform coefficient levels are updated [S1803]. In this case, the update is performed by accumulation scheme for adding a transform coefficient level value inputted for 4×4 or 8×8 luminance block to a previous value. The scaled transform coefficients are updated in a manner of adding an inputted residual signal to a previously scaled transform coefficient value.

In this case, the transform coefficient means a scalar quantity related to 1- or 2-dimensional frequency index in an inverse transform process of decoding. The transform coefficient level means an integer indicating a value related to 2-dimensional frequency index prior to scaling the transform coefficient value. And, the transform coefficient and the transform coefficient level have the relation as the following Equation 1.

transform coefficient=transform coefficient level*scaling factor Equation 1

As a result of the step S1822, if the prediction mode is not inferred, intra-picture prediction is performed on a current layer by the same method of the conventional Intra_{—}4×4, Intra_{—}8×8 or Intra_{—}16×16 [S1804]. Predicted data is added to the residual signal to construct a sample. In this case, the constructed sample value means pixel values prior to performing the deblocking filtering.

On the contrary, as a result of the step S1801, if the type of the current macroblock is not the intra-prediction, decoding for motion vector and reference index is performed [S1805]. If the prediction mode is inferred, a value initialized in a current status is used intact to infer a L0/L1 prediction utilization flag, a reference index and a motion vector value. In this case, when a field motion_prediction_flag exists, if its value is 1, a value initialized before decoding a current layer is used as a motion vector predicted value. Otherwise, this decoding is conceptionally similar to the conventional H.264 motion information decoding.

Subsequently, scaled transform coefficients and transform coefficient levels are calculated and update is then performed [S1806].

FIG. 19 is a flowchart for a decoding process for a spatial scalable bitstream.

Referring to FIG. 19, it is checked whether a type (mb_type) of macroblock to be currently coded is intra-prediction [S1901]. If the type of the current macroblock is the intra-prediction, it is checked whether a prediction mode for the current macroblock or a block is inferred [S1902].

If the prediction mode is inferred, a re-sampling process for intra-samples is performed [S1903]. This corresponds to an upsampling process for mapping data of a base layer to a position of an enhanced layer for interlayer prediction.

Calculations of scaled transform coefficients and transform coefficient levels are performed [S1909].

As a result of the step S1902, if the prediction mode is not inferred, intra-picture prediction and a sample constructing process are performed [S1904]. Intra-picture prediction is performed on a current layer by the same method of the conventional Intra_{—}4×4, Intra_{—}8×8 or Intra_{—}16×16.

Predicted data is added to the residual signal to construct a sample. In this case, the constructed sample value means pixel values prior to performing the deblocking filtering. Calculations of scaled transform coefficients and transform coefficient levels are performed [S1909].

Meanwhile, as a result of the step S1901, if the type of the current macroblock is not the intra-prediction, a re-sampling process for motion data is performed. In this case, the motion data re-sampling process includes the steps of calculating a corresponding position in a base layer for a macroblock or block partition of an enhanced layer and inferring a macroblock type, a sub-macroblock type, a reference index and a motion vector value at the calculated position [S1905]. The re-sampling process for the intra-samples corresponds to an upsampling process for mapping data of the base layer to a position of the enhanced layer for interlayer prediction [S1906]. In case of interlayer prediction for non-intra-macroblock, a sample value is not used. In particular, since motion compensation is not performed on the non-intra-macroblock on a base layer, a memory for storing pixels of a reference picture is not necessary for the base layer decoding process.

If the base layer is coded in intra-mode, a sample value decoded in the base layer is used for the enhanced layer. In this case, upsampling uses 4-tap filter and a filer coefficient is defined different according to a calculated position in a vertical direction. In case of a field picture, re-sampling in a vertical direction uses the same scheme of the 6-tap filter used for the conventional pixel interpolation. In case of a residual signal, upsampling is performed using bi-linear interpolation.

Subsequently, decoding for a motion vector and a reference index is performed [S1907]. A value initialized in a current status is used intact to infer a L0/L1 prediction utilization flag, a reference index and a motion vector value. In this case, when a field of motion_prediction_flag exists, if its value is 1, a value initialized before decoding a current layer is used as a motion vector predicted value. Otherwise, this decoding is conceptionally similar to the conventional H.264 motion information decoding.

Subsequently, through a re-sampling process for a residual signal [S1908], scaled transform coefficients and transform coefficient levels are calculated [S1909].

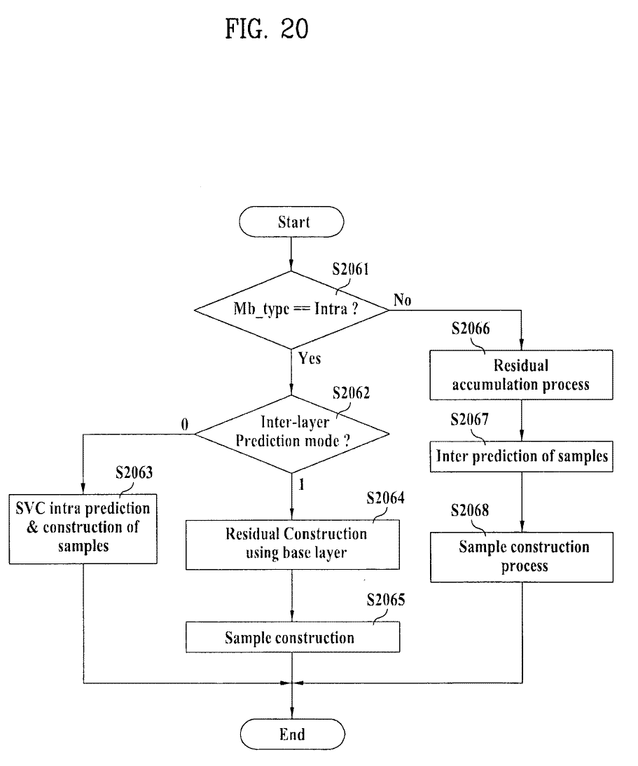

FIG. 20 is a flowchart for a decoding process for enhanced layer data.

Referring to FIG. 20, it is checked whether a type (mb_type) of macroblock to be currently coded is intra-prediction [S2001]. If the type of the current macroblock is the intra-prediction, an interlayer prediction mode is checked [S2002].

If the interlayer prediction mode is ‘0’, intra-prediction and a sample constructing process are performed [S2103]. Intra-picture prediction is performed on a current layer by the same method of the conventional Intra_{—}4×4, Intra_{—}8×8 or Intra_{—}16×16. Predicted data is added to a residual signal to construct a sample. In this case, the constructed sample value means pixel values prior to performing the deblocking filtering.

If the interlayer prediction mode is ‘1’, a residual signal is generated using a base layer [S2004]. Sample is then constructed from the residual signal [S2005].

Meanwhile, as a result of the step S2001, if the type of the current macroblock is not the intra-prediction, a residual accumulation process is performed [S2006]. If inverse transform is performed on a scaled transform coefficient, it is able to generate a residual signal. The residual accumulation process is an accumulation process for adding a value of a residual signal calculated and stored in the decoding process of the base layer and a residual signal calculated in the current layer to each other.

Subsequently, inter-prediction is performed on the current layer [S2007]. The inter-predicted data is added to the residual signal to generate a sample signal [S2008].

Furthermore, the present invention is even more effective when applied to mobile and portable receivers, which are also liable to a frequent change in channel and which require protection (or resistance) against intense noise.

—A Method of Transmission—

In order to extract the mobile service data from the channel through which IPTV service data are transmitted and to decode the extracted IPTV service data, system information is required. Such system information may also be referred to as service information. The system information may include channel information, event information, etc. In the embodiment of the present invention, the PSI/PSIP tables are applied as the system information. However, the present invention is not limited to the example set forth herein. More specifically, regardless of the name, any protocol transmitting system information in a table format may be applied in the present invention.

The PSI table is an MPEG-2 system standard defined for identifying the channels and the programs. The PSIP table is an advanced television systems committee (ATSC) standard that can identify the channels and the programs. The PSI table may include a program association table (PAT), a conditional access table (CAT), a program map table (PMT), and a network information table (NIT). Herein, the PAT corresponds to special information that is transmitted by a data packet having a PID of ‘0’. The PAT transmits PID information of the PMT and PID information of the NIT corresponding to each program. The CAT transmits information on a paid broadcast system used by the transmitting system. The PMT transmits PID information of a transport stream (TS) packet, in which program identification numbers and individual bit sequences of video and audio data configuring the corresponding program are transmitted, and the PID information, in which PCR is transmitted. The NIT transmits information of the actual transmission network.

The PSIP table may include a virtual channel table (VCT), a system time table (STT), a rating region table (RRT), an extended text table (ETT), a direct channel change table (DCCT), an event information table (EIT), and a master guide table (MGT). The VCT transmits information on virtual channels, such as channel information for selecting channels and information such as packet identification (PID) numbers for receiving the audio and/or video data. More specifically, when the VCT is parsed, the PID of the audio/video data of the broadcast program may be known. Herein, the corresponding audio/video data are transmitted within the channel along with the channel name and the channel number.

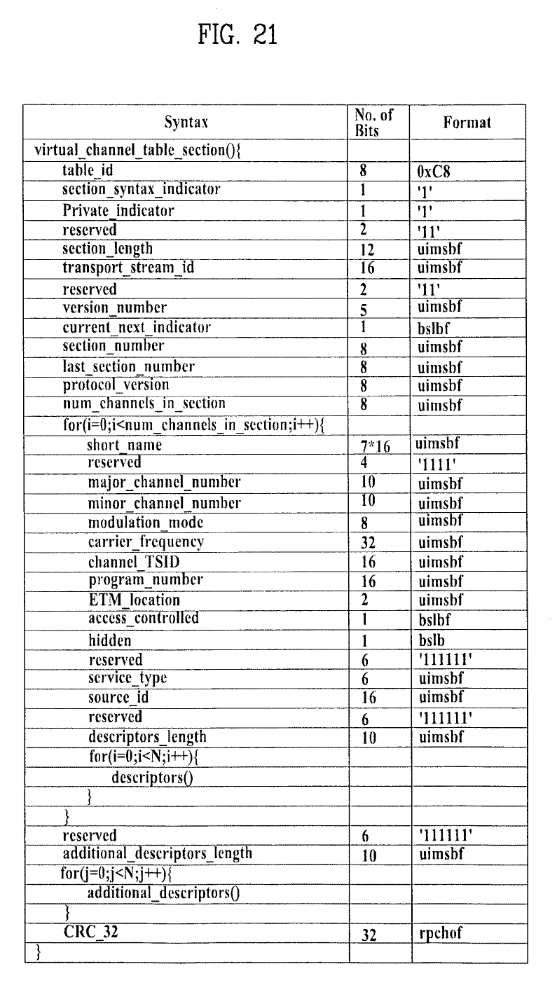

FIG. 21 illustrates a VCT syntax according to an embodiment of the present invention. The VCT syntax of FIG. 21 is configured by including at least one of a table_id field, a section_syntax_indicator field, a private_indicator field, a section_length field, a transport_stream_id field, a version_number field, a current_next_indicator field, a section_number field, a last_section_number field, a protocol_version field, and a num_channels_in_section field.

The VCT syntax further includes a first ‘for’ loop repetition statement that is repeated as much as the num_channels_in_section field value. The first repetition statement may include at least one of a short_name field, a major_channel_number field, a minor_channel_number field, a modulation_mode field, a carrier_frequency field, a channel_TSID field, a program_number field, an ETM_location field, an access_controlled field, a hidden field, a service_type field, a source_id field, a descriptor_length field, and a second ‘for’ loop statement that is repeated as much as the number of descriptors included in the first repetition statement. Herein, the second repetition statement will be referred to as a first descriptor loop for simplicity. The descriptor descriptors( ) included in the first descriptor loop is separately applied to each virtual channel.

Furthermore, the VCT syntax may further include an additional_descriptor_length field, and a third ‘for’ loop statement that is repeated as much as the number of descriptors additionally added to the VCT. For simplicity of the description of the present invention, the third repetition statement will be referred to as a second descriptor loop. The descriptor additional_descriptors( ) included in the second descriptor loop is commonly applied to all virtual channels described in the VCT.

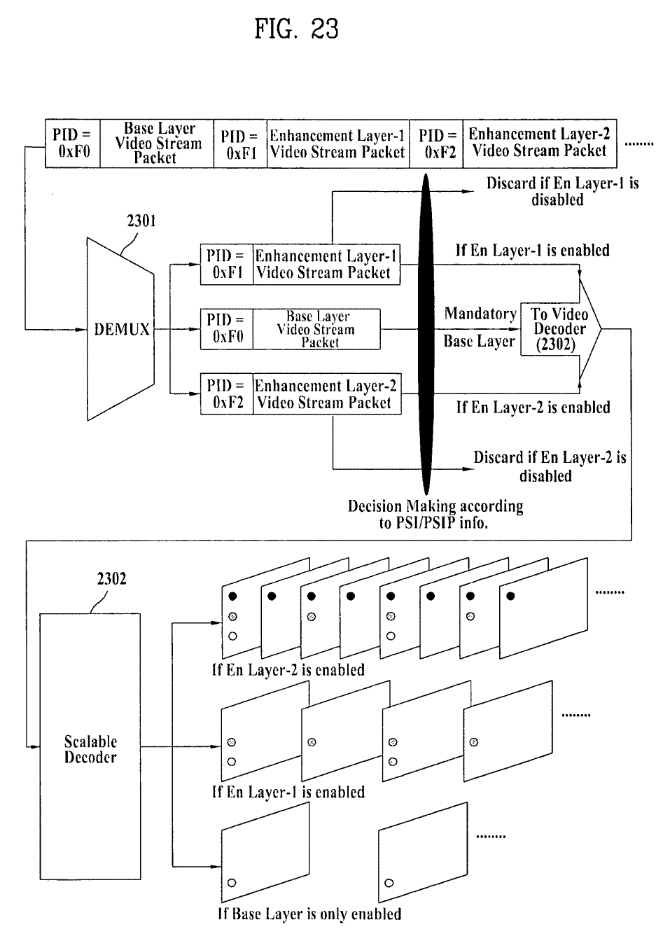

As described above, referring to FIG. 23, the table_id field indicates a unique identifier (or identification) (ID) that can identify the information being transmitted to the table as the VCT. More specifically, the table_id field indicates a value informing that the table corresponding to this section is a VCT. For example, a 0xC8 value may be given to the table_id field.

The version_number field indicates the version number of the VCT. The section_number field indicates the number of this section. The last_section_number field indicates the number of the last section of a complete VCT. And, the num_channel_in_section field designates the number of the overall virtual channel existing within the VCT section. Furthermore, in the first ‘for’ loop repetition statement, the short_name field indicates the name of a virtual channel. The major_channel_number field indicates a ‘major’ channel number associated with the virtual channel defined within the first repetition statement, and the minor_channel_number field indicates a ‘minor’ channel number. More specifically, each of the channel numbers should be connected to the major and minor channel numbers, and the major and minor channel numbers are used as user reference numbers for the corresponding virtual channel.

The program_number field is shown for connecting the virtual channel having an MPEG-2 program association table (PAT) and program map table (PMT) defined therein, and the program_number field matches the program number within the PAT/PMT. Herein, the PAT describes the elements of a program corresponding to each program number, and the PAT indicates the PID of a transport packet transmitting the PMT. The PMT described subordinate information, and a PID list of the transport packet through which a program identification number and a separate bit sequence, such as video and/or audio data configuring the program, are being transmitted.

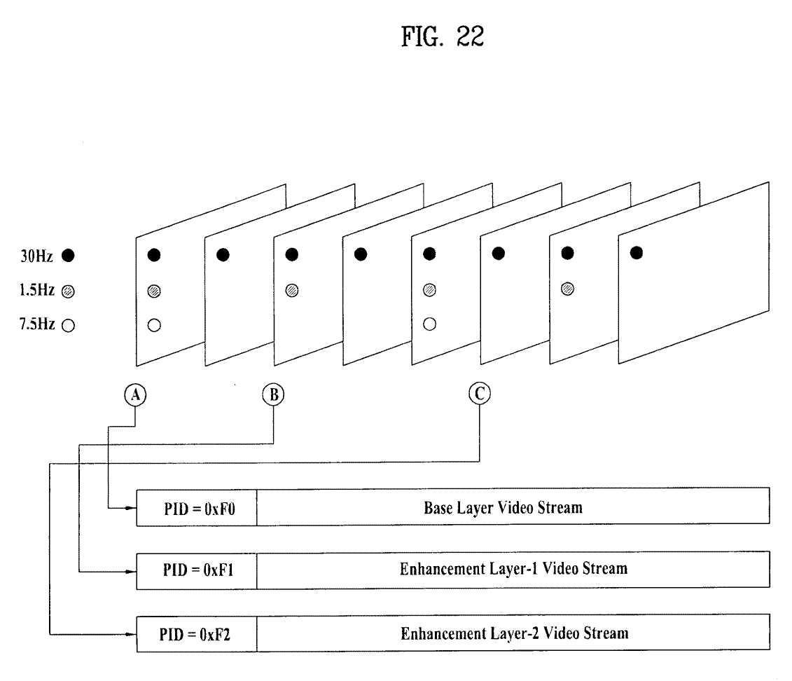

FIG. 22 illustrates an embodiment of a method for transmitting data of each layer of scalable video according to the present invention.

In an embodiment of the present invention, different Packet Identifications (PIDs) are allocated to scalable video data of a plurality of layers to construct respective ESs of the layers.

For example, a PID value inserted into a header of a video stream packet including a video ES of the base layer is different from a PID value inserted into a header of a video stream packet including a video ES of a first enhancement (or enhanced) layer. In the present invention, a video stream packet includes a header and payload. In an embodiment, 4 bytes are allocated to the header and 184 bytes are allocated to the payload. The present invention is not limited to the specific numbers of bytes allocated to the header and payload since the allocated numbers of bytes can be changed by the system designer.

The procedure for creating a video stream packet by allocating a different PID to scalable video data of each layer can be performed at the transmission system and may also by performed at the transmitter.

For example, a PID value of 0xF0 can be allocated to scalable video data of the base layer, a PID value of 0xF1 can be allocated to scalable video data of the first enhancement layer, and a PID value of 0xF2 can be allocated to scalable video data of the second enhancement layer. The PID values described in the present invention are only examples and the scope of the present invention is not limited by the specific PID values.

In addition, when the group formatter 303 in the transmitter of the present invention allocates the respective scalable video data of the layers to regions A, B, C, and D of a data group, the respective scalable video data of the layers may be allocated to the same region or different regions.

The present invention will be described with reference to an embodiment in which scalable video data of each layer is transmitted by allocating scalable video data of the base layer and allocating scalable video data of the enhanced layer.

FIG. 23 illustrates an embodiment in which the receiving system receives and processes scalable video data transmitted with a different PID allocated to each layer.

The demodulator of the receiving system receives and demodulates scalable video data transmitted with a different PID allocated to each layer and outputs the demodulated scalable video data in a video stream packet format to a demultiplexer 2301. A header of the video stream packet includes a PID enabling identification of payload data of the video stream packet and the payload of the video stream packet includes an ES of scalable video data of a layer indicated by the PID. An example of the demodulator of the receiving system that receives and demodulates scalable video data transmitted with a different PID allocated to each layer is the demodulator described above with reference to FIG. 36. However, these are only examples that do not limit the scope of the present invention.

Although the demultiplexer 2301 in the receiving system may receive any of a video stream packet, an audio stream packet, and a data stream packet and the present invention is described with reference to an embodiment wherein the demultiplexer 2301 receives and processes a video stream packet. A detailed description of procedures for processing audio and data stream packets is omitted herein since reference can be made to the description of the procedure for processing a video stream packet.

The demultiplexer 2301 identifies the layer of the received video stream packet with reference to program table information such as PSI/PSIP and the PID of the received video stream packet.

When the identified layer is the base layer, the demultiplexer 2301 outputs the video stream packet of the base layer to the video decoder 2302. However, when the identified layer is an enhanced or enhancement layer, the demultiplexer 2301 outputs the video stream packet of the enhancement layer to the video decoder 2302 or discards the video stream packet without outputting it to the video decoder 2302.

Whether the demultiplexer 2301 outputs the video stream packet of the enhancement layer to the video decoder 2302 or discards the video stream packet without outputting it to the video decoder 2302 can be determined based on various criteria. In an embodiment of the present invention, the determination is made based on the decoding performance of the video decoder 2302.

More specifically, if the video decoder 2302 is capable of processing video stream packets of an enhancement layer, a video stream packet of the enhancement layer identified by the demultiplexer 2301 is output to the video decoder 2302. For example, if the video decoder 2302 is capable of processing video stream packets of up to the first enhancement layer, video stream packets of the base layer and the first enhancement layer identified by the demultiplexer 2301 are output to the video decoder 2302, whereas video stream packets of the second enhancement layer are discarded without being output to the video decoder 2302.

The video decoder 2302 decodes and outputs a video stream packet received from the demultiplexer 2301 according to a corresponding video decoding algorithm. For example, at least one of an MPEG2 video decoding algorithm, an MPEG2 video decoding algorithm, an MPEG4 video decoding algorithm, an H.264 video decoding algorithm, an SVC video decoding algorithm, and a VC-1 video decoding algorithm can be applied as the video decoding algorithm.

For example, if the video decoder 2302 is capable of processing video stream packets of only the base layer, the demultiplexer 2301 outputs video stream packets of only the base layer to the video decoder 2302 so that the video decoder 2302 decodes the video stream packets of the base layer.

In another example, if the video decoder 2302 is capable of processing video stream packets of up to the first enhancement layer, the demultiplexer 2301 outputs video stream packets of only the base and first layers to the video decoder 2302 so that the video decoder 2302 decodes the video stream packets of the base and first layers.

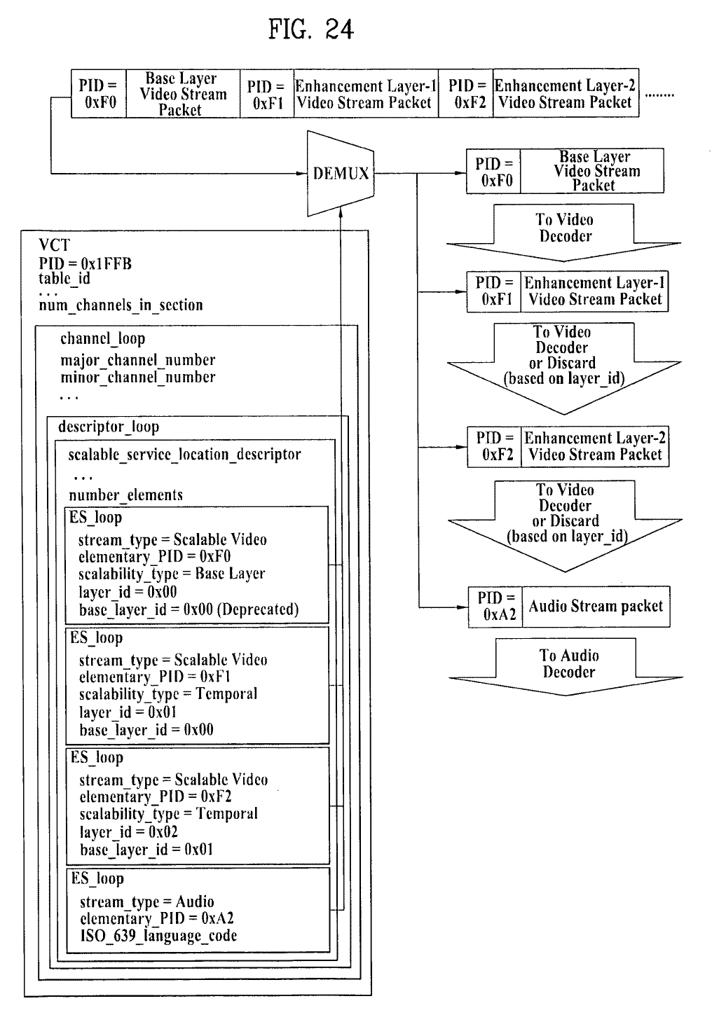

FIG. 24 is a block diagram illustrating an embodiment of a method in which the demultiplexer 2301 of FIG. 23 processes scalable video data of each layer using a VCT among the PSI/PSIP information.

More specifically, the receiving system receives a VCT and parses a scalable_service_location_descriptor in the received VCT to determine whether or not a corresponding video stream packet is scalable video for IPTV services (i.e., IPTV scalable video). If it is determined that the corresponding video stream packet is IPTV scalable video, the demultiplexer 2301 determines whether or not the video stream packet is scalable video data of the base layer. If the video stream packet is scalable video data of the base layer, the demultiplexer 2301 transfers the video stream packet to the video decoder 2302.

If it is determined that the video stream packet is scalable video data of an enhancement layer although the video stream packet is IPTV scalable video, the demultiplexer 2301 outputs the video stream packet to the video decoder 2302 or discards the video stream packet without outputting it to the video decoder 2302 according to the decoding capabilities of the video decoder 2302.

For example, if a stream_type field value in the scalable_service_location_descriptor of the received VCT indicates IPTV scalable video and a layer_id field value indicates the base layer, the demultiplexer 2301 unconditionally outputs the video stream packet to the video decoder 2302. In another example, if a stream_type field value in the scalable_service_location_descriptor of the received VCT indicates IPTV scalable video and a layer_id field value indicates the first enhancement layer, the demultiplexer 2301 outputs the video stream packet to the video decoder 2302 or discards the video stream packet without outputting it to the video decoder 2302.

That is, in the present invention, the VCT may include a first loop (channel_loop) including a ‘for’ loop that is repeated the number of times corresponding to the num_channels_in_section field value as in FIG. 21.

The first loop includes at least one of a short_name field, a major_channel_number field, a minor_channel_number field, a modulation_mode field, a carrier_frequency field, a channel_TSID field, a program_number field, an ETM_location field, an access_controlled field, a hidden field, a service_type field, a source_id field, a descriptor_length field, and a second loop including a ‘for’ loop that is repeated the number of times corresponding to the number of descriptors included in the first loop. A detailed description of each field of the first loop is omitted herein since reference can be made to FIG. 21.

In the present invention, the second loop is referred to as a “descriptor loop” for ease of explanation. Descriptors( ) included in the descriptor loop are descriptors that are applied respectively to the virtual channels.

In an embodiment of the present invention, the descriptor loop includes a scalable_service_location_descriptor( ) that transmits information for identifying scalable video data of each layer.

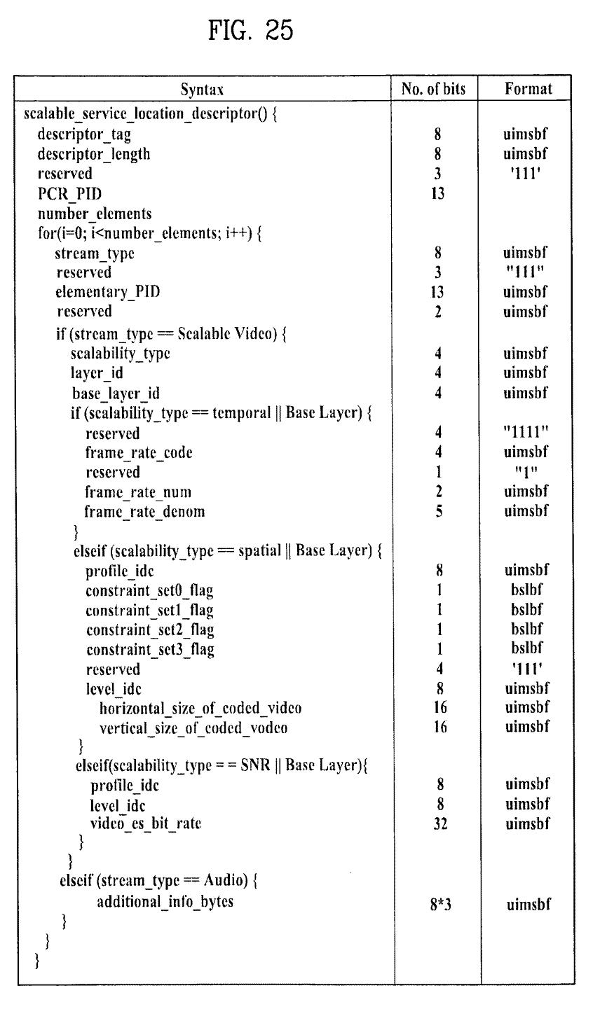

FIG. 25 illustrates an embodiment of a bitstream syntax structure of a scalable_service_location_descriptor according to the present invention.

The scalable_service_location_descriptor( ) of FIG. 25 may include at least one of a descriptor_tag field, a descriptor_length field, a PCR_PID field, a number_elements field, and a loop including a ‘for’ loop that is repeated the number of times corresponding to the value of the number_elements field. In the present invention, the loop including a ‘for’ loop that is repeated the number of times corresponding to the value of the number_elements field is referred to as an ES loop for ease of explanation.

Each ES loop may include at least one of a stream_type field and an elementary_PID field.

When the stream_type field value indicates scalable video for IPTV service (IPTV scalable video), each ES loop may include at least one of a scalability_type field, a layer_id field, and a base_layer_id field.

When the scalability_type field value indicates temporal scalability or the base layer, each ES loop may further include at least one of a frame_rate_code field, a frame_rate_num field, and a frame_rate_denom field. And, the each ES loop may change a using field according to the scalability_type field value.

When the scalability_type field value indicates spatial scalability or the base layer, each ES loop may further include at least one of a profile_idc field, constraint_set0_flag˜constraint_set3_flag fields, and a level_idc field. The level_idc field further includes at least one of a horizontal_size_of_coded_video field and vertical_size_of_coded_video field. The horizontal_size_of_coded_video field represents horizontal size of video data by pixel unit and the vertical_size_of_coded_video field represents vertical size of video data by pixel unit.

When the scalability_type field value indicates SNR scalability or the base layer, each ES loop may further include at least one of a profile_idc field, a level_idc field and video_es_bit_rate field. The video_es_bit_rate field represents bitrate of corresponding to the video by bit per second unit.

When the stream_type field value indicates audio for IPTV (IPTV audio), each ES loop may further include an additional_info_type field.

In an embodiment of the syntax of FIG. 25 constructed as described above, the descriptor_tag field can be allocated 8 bits to represent a value for uniquely identifying the descriptor.

In an embodiment, the descriptor_length field can be allocated 8 bits to represent the descriptor length.

In an embodiment, the PCR_PID field can be allocated 13 bits to represent a PID of a program clock reference elementary stream. That is, the PCR_PID field represents a PID of a transport stream packet including an effective PCR field in a program specified by the program_number field.

In an embodiment, the number_elements field can be allocated 8 bits to represent the number of ESs included in the corresponding descriptor.

The number of repetitions of an ES loop described below is determined according to the number_elements field value.

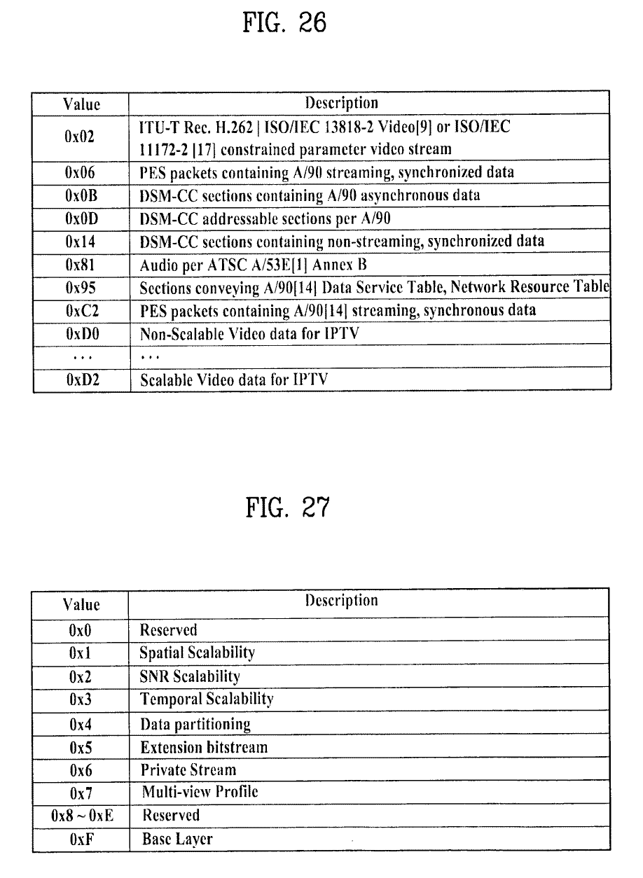

In an embodiment, the stream_type field can be allocated 8 bits to represent the type of the corresponding ES. FIG. 26 illustrates example values that can be allocated to the stream_type field according to the present invention and example definitions of the values. As shown in FIG. 26, ITU-T Rec. H.262|ISO/IEC 13818-2 Video or ISO/IEC 11172-2 constrained parameter video stream, PES packets containing A/90 streaming synchronized data, DSM-CC sections containing A/90 asynchronous data, DSM-CC addressable sections per A/90, DSM-CC sections containing non-streaming synchronized data, Audio per ATSC A/53E Annex B, Sections conveying A/90 Data Service Table, Network Resource Table, and PES packets containing A/90 streaming synchronous data can be applied as the stream types. On the other hand, according to the present invention, Non-Scalable Video data for IPTV, Audio data for IPTV, and Scalable Video data for IPTV can further be applied as the stream types.

In an embodiment, the elementary_PID field can be allocated 13 bits to represent a PID of a corresponding ES.

When the stream_type field value indicates IPTV scalable video, each ES loop may include at least one of a scalability_type field, a layer_id field, and a base_layer_id field.

In an embodiment, the scalability_type field can be allocated 4 bits to represent the type of scalability of a corresponding scalable video stream. FIG. 27 illustrates example values that can be allocated to the scalability_type field according to the present invention and example definitions of the values. In the embodiment of FIG. 27, the scalability_type field indicates spatial scalability if the value of the scalability_type field is “0x1”, SNR scalability if “0x2”, temporal scalability if “0x03”, and the base layer if “0xF”.

The layer_id field can be allocated 4 bits to represent layer information of a corresponding scalable video stream and is preferably analyzed together with the scalability_type field. If the corresponding video stream is the base layer, a value of “0x0” is allocated to the layer_id field. The higher the layer, the higher the value of the layer_id field. For example, a value of “0x01” can be allocated to the layer_id field of the first enhancement layer and a value of “0x02” can be allocated to the layer_id field of the second enhancement layer. Here, the values allocated to the layer_id field are preferred embodiments or only examples without limiting the scope of the present invention.

In an embodiment, the base_layer_id field can be allocated 4 bits. When a corresponding scalable video stream is an enhancement layer stream, the base_layer_id field represents a layer_id value of a lower layer referenced by the stream. The base_layer_id field is ignored (or deprecated) when the stream is of the base layer. For example, when the corresponding scalable video stream is a stream of the first enhancement layer (Enhancement Layer 1), the layer_id value of a lower layer referenced by the scalable video stream of the first enhancement layer is equal to the layer_id value of the base layer (i.e., base_layer_id=0x00). In another example, when the corresponding scalable video stream is a stream of the second enhancement layer (Enhancement Layer 2), the layer_id value of a lower layer referenced by the scalable video stream of the second enhancement layer is equal to the layer_id value of the first enhancement layer (i.e., base_layer_id=0x01).

On the other hand, when the scalability_type field value indicates temporal scalability (for example, 0x3) or the base layer (for example, 0xF), each ES loop may further include at least one of a frame_rate_code field, a frame_rate_num field, and a frame_rate_denom field.

In an embodiment, the frame_rate_code field can be allocated 4 bits and is used to calculate the frame rate of the corresponding scalable video stream. For example, the frame_rate_code field can indicate a frame_rate_code field value defined in ISO/IEC 13818-2.

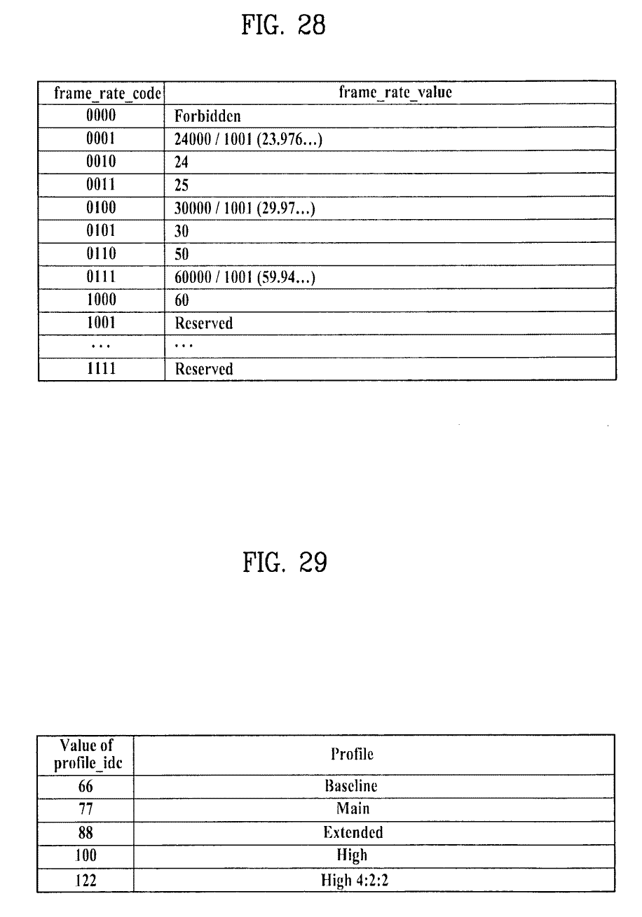

The frame rate of the corresponding scalable video stream can be calculated in the following manner. That is, frame_rate=frame_rate_value*(frame_rate_num+1)/(frame_rate_denom+1). Here, the frame_rate_value is an actual frame rate value extracted from the frame_rate_code. FIG. 28 illustrates example values that can be allocated to the frame_rate_code field according to the present invention and example definitions of the values. For example, in FIG. 28, a frame_rate_code field value of “1000” indicates that the frame rate is 60 Hz.

In an embodiment, the frame_rate_num field can be allocated 2 bits and is used to calculate the frame rate of the corresponding scalable video stream. However, the frame_rate_num field is set to “0” when the frame rate is directly extracted from the frame_rate_code field.

In an embodiment, the frame_rate_denum field can be allocated 5 bits and is used to calculate the frame rate of the corresponding scalable video. However, the frame_rate_denum field is set to “0” when the frame rate is directly extracted from the frame_rate_code field.

When the scalability_type field value indicates spatial scalability (for example, 0x1) or the base layer (for example, 0xF), each ES loop may further include at least one of a profile_idc field, constraint_set0_flag˜constraint_set3_flag fields, and a level_idc field.

In an embodiment, the profile_idc field can be allocated 8 bits to represent a profile of a scalable video stream that is transmitted. For example, a profile_idc field defined in ISO/IEC 14496-10 can be directly applied as the profile_idc field in this embodiment. FIG. 29 illustrates example values that can be allocated to the profile_idc field according to the present invention and example definitions of the values. For example, a profile_idc field value of “66” indicates a baseline profile.

In an embodiment, each of the constraint_set0_flag˜constraint_set3_flag fields can be allocated 1 bit to represent whether or not a constraint of the corresponding profile is satisfied.

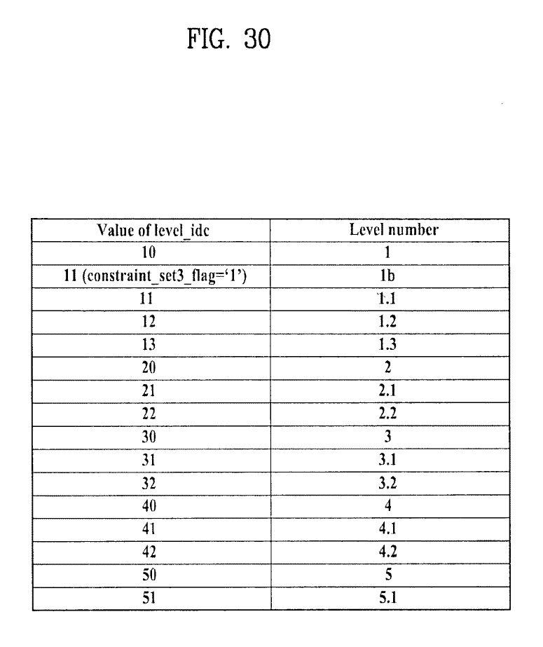

In an embodiment, the level_idc field can be allocated 8 bits to represent the level of a scalable video stream that is transmitted. For example, a level_idc field defined in ISO/IEC 14496-10 can be directly applied as the level_idc field in this embodiment. FIG. 30 illustrates example values that can be allocated to the level_idc field according to the present invention and example definitions of the values. For example, a level_idc field value of “11” indicates Level 1.1.

When the stream_type field value indicates IPTV audio, each ES loop may further include an additional_info_byte field. The additional_info_byte field may include an ISO_{—}639_language_code field representing the language code of the corresponding ES.

The order, the positions, and the meanings of the fields allocated to the scalable_service_location_descriptor( ) shown in FIG. 25 are embodiments provided for better understanding of the present invention and the present invention is not limited to these embodiments since the order, the positions, and the meanings of the fields allocated to the scalable_service_location_descriptor( ) and the number of fields additionally allocated thereto can be easily changed by those skilled in the art.

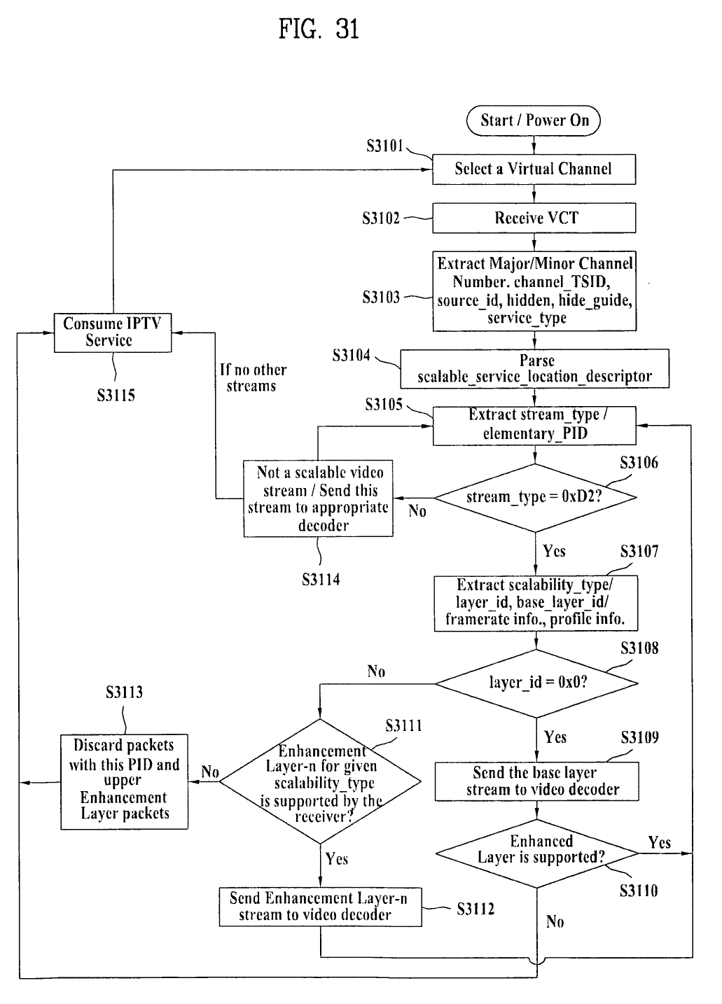

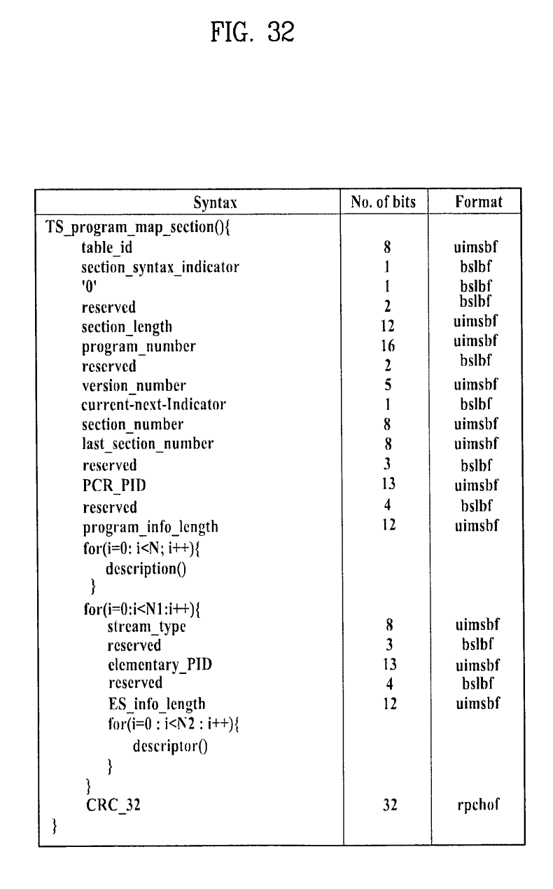

FIG. 31 is a flow chart illustrating an embodiment of a method in which the demultiplexer 2301 of FIG. 23 processes scalable video data of each layer using a VCT among the PSI/PSIP information.

Specifically, when a virtual channel is selected (S3101), the demultiplexer 2301 receives a VCT including information of the selected virtual channel (S3102). The demultiplexer 2301 then parses the VCT to extract information such as a Major/Minor Channel Number, a channel_TSID field, a source_id field, a hidden field, a hide_guide field, and a service_type field (S3103). Then, the demultiplexer 2301 parses a scalable_service_location_descriptor( ) in the VCT (S3104) and extracts information such as stream_type and elementary_PID from the scalable_service_location_descriptor( ) (S3105).

The demultiplexer 2301 then determines whether or not the stream_type field value is “0xD2” (S3106). For example, if the value of the stream_type field is “0xD2”, the stream_type field indicates that the stream is scalable video data for IPTV service.

Accordingly, if it is determined at step S3106 that the stream_type field value is “0xD2”, the demultiplexer 2301 extracts information such as scalability_type, layer_id, base_layer_id field, frame rate information (for example, frame_rate_code, frame_rate_num, frame_rate_denom), and profile information (for example, profile_idc, constraint_set0_flag˜constraint_set3_flag, level_idc) from the scalable_service_location_descriptor( ) (S3107).

The demultiplexer 2301 then determines whether or not the layer_id field value is “0x0” (S3108). For example, if the layer_id field value is “0x0”, this indicates that the corresponding video stream is of the base layer.

Accordingly, if it is determined at step S3108 that the layer_id field value is “0x0”, the demultiplexer 2301 outputs the scalable video data of the base layer to the video decoder 2302 (S3109). Then, the demultiplexer 2301 determines whether or not the video decoder 2302 supports an enhancement layer (S3110). The demultiplexer 2301 returns to the above step S3105 if it is determined at step S3110 that the video decoder 2302 supports an enhancement layer and proceeds to step S3115 if it is determined that the video decoder 2302 does not support an enhancement layer. At step S3115, video decoding is performed on a video stream of only the base layer through the video decoder 2302 to provide an IPTV service to the user.

On the other hand, if it is determined at the above step S3108 that the layer_id field value is not “0x0”, the demultiplexer 2301 proceeds to step S3111 since the layer_id field value indicates that the corresponding video stream is of an enhancement layer. At step S3111, the demultiplexer 2301 determines whether or not the video decoder 2302 supports scalable video data of the enhancement layer. If it is determined that the video decoder 2302 supports scalable video data of the enhancement layer, the demultiplexer 2301 outputs the scalable video data of the enhancement layer to the video decoder 2302 and returns to step S3105 (S3112) For example, if it is determined at step S3111 that the receiving system supports the first enhancement layer, the demultiplexer 2301 outputs scalable video data of the first enhancement layer to the video decoder 2302 at step S3112.

If it is determined at step S3111 that the video decoder 2302 does not support the enhancement layer, the demultiplexer 2301 discards scalable video data (specifically, packets with the corresponding PID) of the enhancement layer without outputting the scalable video data to the video decoder 2302. Here, the demultiplexer 2301 also discards scalable video data of any enhancement layer higher than the enhancement layer without outputting the scalable video data to the video decoder 2302. For example, if it is determined at step S3111 that the receiving system does not support the first enhancement layer, the demultiplexer 2301 discards scalable video data of the first and second enhancement layers without outputting the scalable video data to the video decoder 2302 at step S3113.

If it is determined at the above step S3106 that the stream_type field value is not “0xD2” (i.e., the corresponding stream is not IPTV scalable video data), the demultiplexer 2301 proceeds to step S3114. At step S3114, the demultiplexer 2301 outputs the received stream to the corresponding decoder. Here, if another stream remains, the demultiplexer 2301 returns to step S3105, otherwise it proceeds to step S3115.

For example, if the video decoder 2302 supports up to the first enhancement layer, video decoding is performed on scalable video data of the base layer and the first enhancement layer to provide an IPTV service to the user at the above step S3115.

FIG. 32 illustrates a PMT syntax according to an embodiment of the present invention.

table_id is an 8 bit field, which in the case of a TS_program_map_section shall be always set to ‘0x02’. section_syntax_indicator is a 1-bit field which shall be set to ‘1’. section_length is a 12 bit field, the first two bits of which shall be ‘00’. It specifies the number of bytes of the section starting immediately following the section_length field, and including the CRC. program_number is a 16 bit field. It specifies the program to which the program_map_PID is applicable. One program definition shall be carried within only one TS_program_map_section. This implies that a program definition is never longer than 1016 bytes. The program_number may be used as a designation for a broadcast channel, for example. By describing the different elementary streams belonging to a program, data from different sources (e.g. sequential events) can be concatenated together to form a continuous set of streams using a program_number.

version_number (5 bit) field is the version number of the TS_program_map_section. The version number shall be incremented by 1 when a change in the information carried within the section occurs. Upon reaching the value 31, it wraps around to 0. Version number refers to the definition of a single program, and therefore to a single section. When the current_next_indicator is set to ‘1’, then the version_number shall be that of the currently applicable TS_program_map_section. When the current_next_indicator is set to ‘0’, then the version_number shall be that of the next applicable TS_program_map_section. current_next_indicator is a 1-bit field, which when set to ‘1’ indicates that the TS_program_map_section sent is currently applicable. When the bit is set to ‘0’, it indicates that the TS_program_map_section sent is not yet applicable and shall be the next TS_program_map_section to become valid. section_number is the value of this 8 bit field shall be always ‘0x00’. last_section_number is the value of this 8 bit field shall be always ‘0x00’.

PCR_PID is a 13 bit field indicating the PID of the Transport Stream packets which shall contain the PCR fields valid for the program specified by program_number. If no PCR is associated with a program definition for private streams then this field shall take the value of 0x1FFF. program_info_length is a 12 bit field, the first two bits of which shall be ‘00’. It specifies the number of bytes of the descriptors immediately following the program_info_length field. stream_type is an 8 bit field specifying the type of elementary stream or payload carried within the packets with the PID whose value is specified by the elementary_PID. elementary_PID is a 13 bit field specifying the PID of the Transport Stream packets which carry the associated elementary stream or payload. ES_info_length is a 12 bit field, the first two bits of which shall be ‘00’. It specifies the number of bytes of the descriptors of the associated elementary stream immediately following the ES_info_length field.

CRC_32 is a 32 bit field that contains the CRC value that gives a zero output of the registers in the decoder defined after processing the entire Transport Stream program map section.

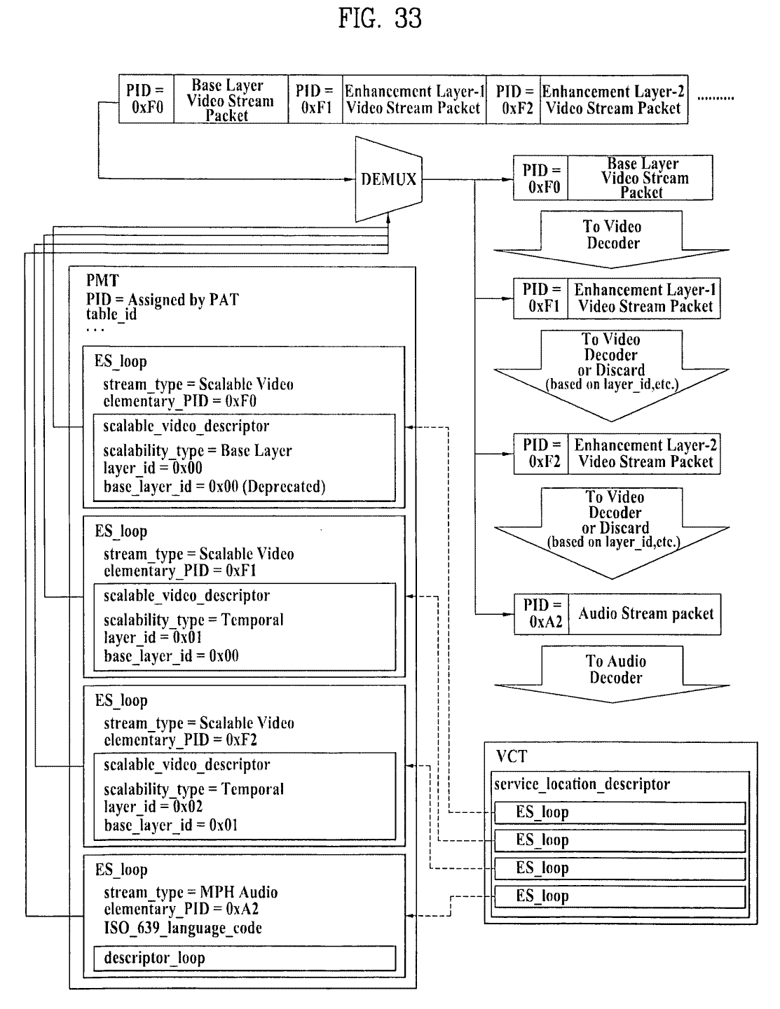

FIG. 33 is a block diagram illustrating an embodiment of a method in which the demultiplexer 2301 of FIG. 75 processes scalable video data of each layer using a PMT among the program table information such as PSI/PSIP information.

More specifically, the receiving system receives a PMT and parses a scalable_video_descriptor in the received PMT to determine whether or not a corresponding video stream packet is scalable video for IPTV services (i.e., IPTV scalable video). If it is determined that the corresponding video stream packet is IPTV scalable video, the demultiplexer 2301 determines whether or not the video stream packet is scalable video data of the base layer. If the video stream packet is scalable video data of the base layer, the demultiplexer 2301 transfers the video stream packet to the video decoder 2302.

If it is determined that the video stream packet is scalable video data of an enhancement layer although the video stream packet is IPTV scalable video, the demultiplexer 2301 outputs the video stream packet to the video decoder 2302 or discards the video stream packet without outputting it to the video decoder 2302 according to the decoding capabilities of the video decoder 2302.

For example, if a stream_type field value in the scalable_video_descriptor of the received PMT indicates IPTV scalable video and a layer_id field value indicates the base layer, the demultiplexer 2301 unconditionally outputs the video stream packet to the video decoder 2302. In another example, if a stream_type field value in the scalable_video_descriptor of the received PMT indicates IPTV scalable video and a layer_id field value indicates the first enhancement layer, the demultiplexer 2301 outputs the video stream packet to the video decoder 2302 or discards the video stream packet without outputting it to the video decoder 2302.

That is, the PID of the PMT of the present invention can be obtained from the PAT. The PAT, which is special information transmitted in a packet of PID=0, describes components of a program of each program number and indicates the PID of transport packets carrying PMTs. That is, a PAT table with a PID of 0 is parsed to determine program numbers and PIDs of PMTs.

A PMT obtained from the PAT provides the relations between components of a corresponding program. The PMT describes a program identification number, a list of PIDs of transport packets carrying an individual bitstream such as video or audio that constitutes a corresponding program, and additional information. That is, the PMT carries information indicating PIDs of ESs that are transmitted for constructing a program.

The PMT may include a loop including a ‘for’ loop that is repeated the number of times corresponding to the number of ESs included in a program number. This loop is also referred to as an “ES loop” for ease of explanation.

The ES loop may include at least one of a stream_type field, an elementary_PID field, an ES_info_length field, and a descriptor loop including a ‘for’ loop that is repeated the number of times corresponding to the number of descriptors included in the corresponding ES. Descriptors( ) included in the descriptor loop are descriptors that are applied respectively to the ESs.

The stream_type field indicates the type of the corresponding ES. FIG. 26 illustrates example values that can be allocated to the stream_type field according to the present invention and example definitions of the values. As shown in FIG. 26, ITU-T Rec. H.262|ISO/IEC 13818-2 Video or ISO/IEC 11172-2 constrained parameter video stream, PES packets containing A/90 streaming synchronized data, DSM-CC sections containing A/90 asynchronous data, DSM-CC addressable sections per A/90, DSM-CC sections containing non-streaming synchronized data, Audio per ATSC A/53E Annex B, Sections conveying A/90 Data Service Table, Network Resource Table, and PES packets containing A/90 streaming synchronous data can be applied as the stream types. On the other hand, according to the present invention, Non-Scalable Video data for IPTV, Audio data for IPTV, and Scalable Video data for IPTV can further be applied as the stream types.

In an embodiment, the elementary_PID field represents a PID of a corresponding ES.

In an embodiment of the present invention, if the stream_type field value indicates IPTV scalable video (i.e., if it is 0xD2), the descriptor loop includes a scalable_video_descriptor that carries information for identifying scalable video data of each layer. More specifically, a scalable_video_descriptor is included in a descriptor( ) region of the second loop of the PMT.

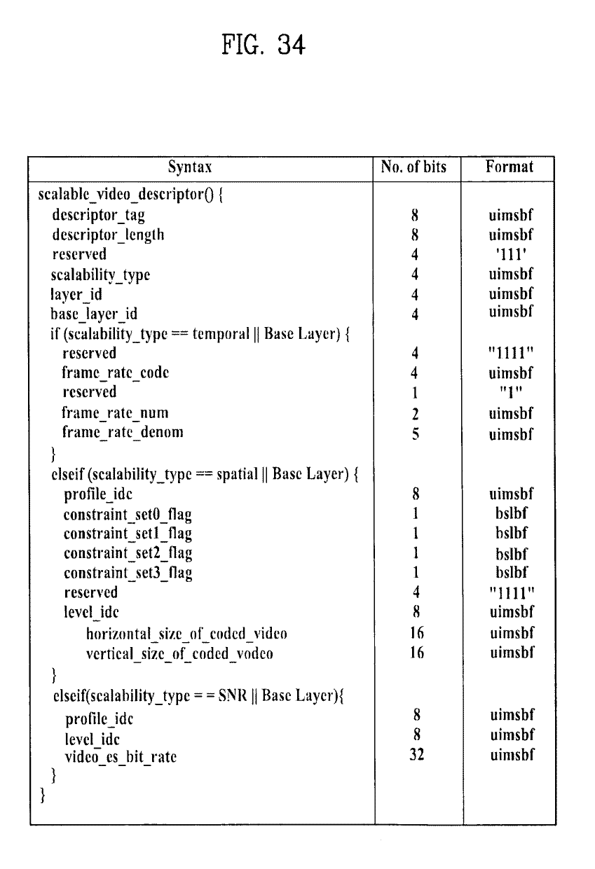

FIG. 34 illustrates an embodiment of a bitstream syntax structure of a scalable_video_descriptor according to the present invention.

The scalable_video_descriptor( ) of FIG. 34 may include at least one of a descriptor_tag field, a descriptor_length field, a scalability_type field, a layer_id field, and a base_layer_id field.

When the scalability_type field value indicates temporal scalability or the base layer, the scalable_video_descriptor( ) may further include frame rate information, for example, at least one of a frame_rate_code field, a frame_rate_num field, and a frame_rate_denom field.

When the scalability_type field value indicates spatial scalability or the base layer, each ES loop may further include at least one of a profile_idc field, constraint_set0_flag˜constraint_set3_flag fields, and a level_idc field. The level_idc field further includes at least one of a horizontal_size_of_coded_video field and vertical_size_of_coded_video field. The horizontal_size_of_coded_video field represents horizontal size of video data by pixel unit and the vertical_size_of_coded_video field represents vertical size of video data by pixel unit.

When the scalability_type field value indicates SNR scalability or the base layer, each ES loop may further include at least one of a profile_idc field, a level_idc field and video_es_bit_rate field. The video_es_bit_rate field represents bitrate of corresponding to the video by bit per second unit.

In an embodiment of the syntax of FIG. 85 constructed as described above, the descriptor_tag field can be allocated 8 bits to represent a value for uniquely identifying the descriptor.

In an embodiment, the descriptor_length field can be allocated 8 bits to represent the descriptor length.

In an embodiment, the scalability_type field can be allocated 4 bits to represent the type of scalability of a corresponding scalable video stream. FIG. 27 illustrates example values that can be allocated to the scalability_type field according to the present invention and example definitions of the values. In the embodiment of FIG. 27, the scalability_type field indicates spatial scalability if the value of the scalability_type field is “0x1”, SNR scalability if “0x2”, temporal scalability if “0x03”, and the base layer if “0xF”.

The layer_id field can be allocated 4 bits to represent layer information of a corresponding scalable video stream and is preferably analyzed together with the scalability_type field. If the corresponding video stream is the base layer, a value of “0x0” is allocated to the layer_id field. The higher the layer, the higher the value of the layer_id field.

In an embodiment, the base_layer_id field can be allocated 4 bits. When a corresponding scalable video stream is an enhancement layer stream, the base_layer_id field represents a layer_id value of a lower layer referenced by the stream. The base_layer_id field is ignored (or deprecated) when the stream is of the base layer. For example, when the corresponding scalable video stream is a stream of the first enhancement layer (Enhancement Layer 1), the layer_id value of a lower layer referenced by the scalable video stream of the first enhancement layer is equal to the layer_id value of the base layer (i.e., base_layer_id=0x00). In another example, when the corresponding scalable video stream is a stream of the second enhancement layer (Enhancement Layer 2), the layer_id value of a lower layer referenced by the scalable video stream of the second enhancement layer is equal to the layer_id value of the first enhancement layer (i.e., base_layer_id=0x01).

On the other hand, when the scalability_type field value indicates temporal scalability (for example, 0x3) or the base layer (for example, 0xF), each ES loop may further include at least one of a frame_rate_code field, a frame_rate_num field, and a frame_rate_denom field.

In an embodiment, the frame_rate_code field can be allocated 4 bits and is used to calculate the frame rate of the corresponding scalable video stream. For example, the frame_rate_code field can indicate a frame_rate_code field value defined in ISO/IEC 13818-2.

The frame rate of the corresponding scalable video stream can be calculated in the following manner. That is, frame_rate=frame_rate_value*(frame_rate_num+1)/(frame_rate_denom+1). Here, the frame_rate_value is an actual frame rate value extracted from the frame_rate_code. FIG. 28 illustrates example values that can be allocated to the frame_rate_code field according to the present invention and example definitions of the values. For example, in FIG. 28, a frame_rate_code field value of “1000” indicates that the frame rate is 60 Hz.

In an embodiment, the frame_rate_num field can be allocated 2 bits and is used to calculate the frame rate of the corresponding scalable video stream. However, the frame_rate_num field is set to “0” when the frame rate is directly extracted from the frame_rate_code field.

In an embodiment, the frame_rate_denum field can be allocated 5 bits and is used to calculate the frame rate of the corresponding scalable video. However, the frame_rate_denum field is set to “0” when the frame rate is directly extracted from the frame_rate_code field.

When the scalability_type field value indicates spatial scalability (for example, 0x1) or the base layer (for example, 0xF), each ES loop may further include at least one of a profile_idc field, constraint_set0_flag˜constraint_set3_flag fields, and a level_idc field. The level_idc field further includes at least one of a horizontal_size_of_coded_video field and vertical_size_of_coded_video field. The horizontal_size_of_coded_video field represents horizontal size of video data by pixel unit and the vertical_size_of_coded_video field represents vertical size of video data by pixel unit.

In an embodiment, the profile_idc field can be allocated 8 bits to represent a profile of a scalable video stream that is transmitted. For example, a profile_idc field defined in ISO/IEC 14496-10 can be directly applied as the profile_idc field in this embodiment. FIG. 29 illustrates example values that can be allocated to the profile_idc field according to the present invention and example definitions of the values. For example, a profile_idc field value of “66” indicates a baseline profile.

In an embodiment, each of the constraint_set0_flag˜_constraint_set3_flag fields can be allocated 1 bit to represent whether or not a constraint of the corresponding profile is satisfied.

In an embodiment, the level_idc field can be allocated 8 bits to represent the level of a scalable video stream that is transmitted. For example, a level_idc field defined in ISO/IEC 14496-10 can be directly applied as the level_idc field in this embodiment. FIG. 30 illustrates example values that can be allocated to the level_idc field according to the present invention and example definitions of the values. For example, a level_idc field value of “11” indicates Level 1.1.

The order, the positions, and the meanings of the fields allocated to the scalable_video_descriptor( ) shown in FIG. 34 are embodiments provided for better understanding of the present invention and the present invention is not limited to these embodiments since the order, the positions, and the meanings of the fields allocated to the scalable_video_descriptor( ) and the number of fields additionally allocated thereto can be easily changed by those skilled in the art.

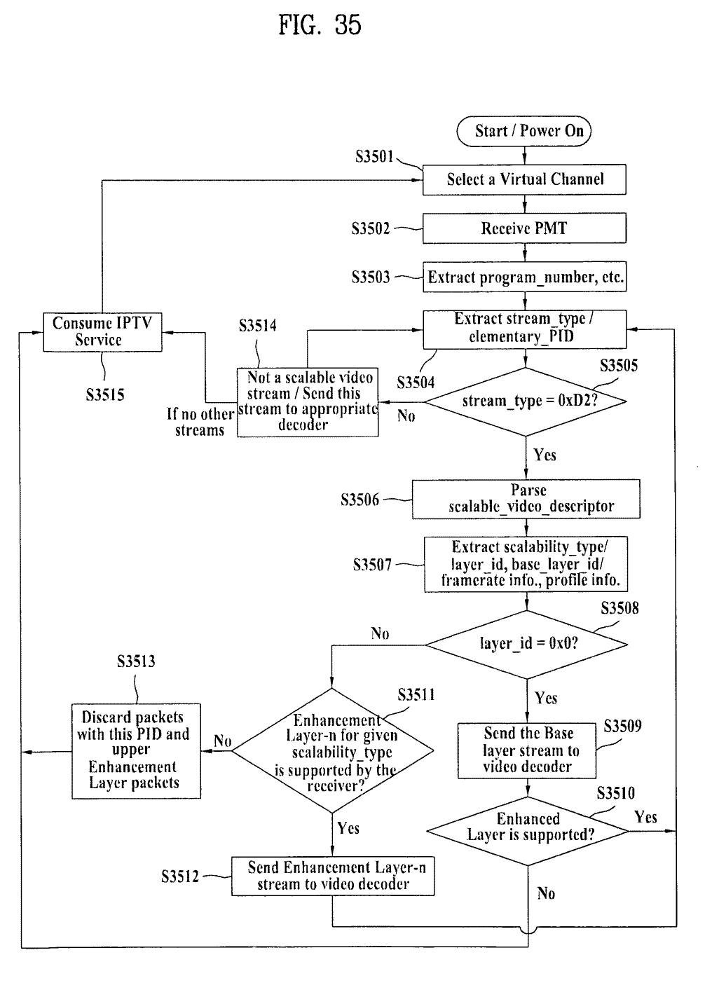

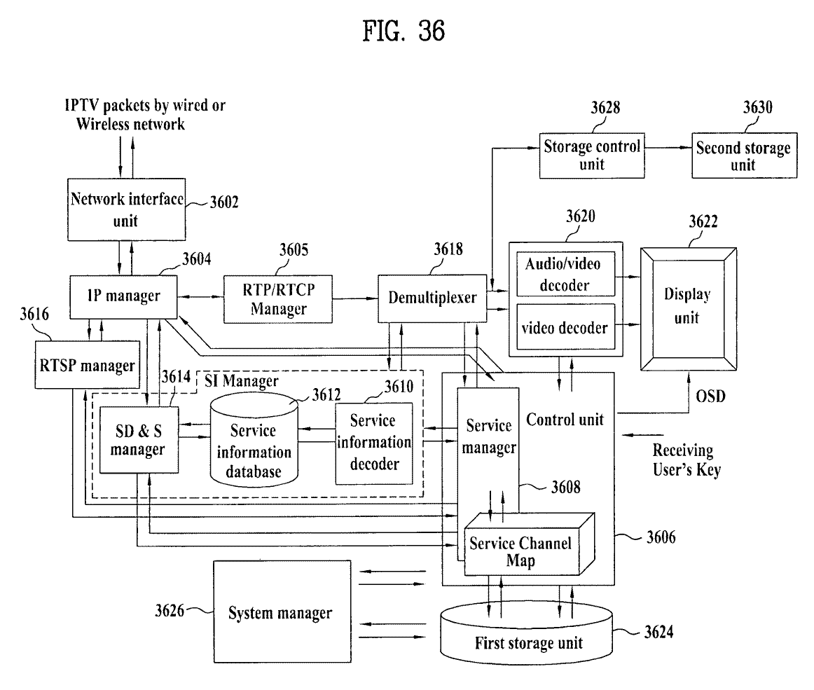

FIG. 35 is a flow chart illustrating an embodiment of a method in which the demultiplexer 2301 of FIG. 23 processes scalable video data of each layer using a PMT among the PSI/PSIP information.

Specifically, when a virtual channel is selected (S3501), the demultiplexer 2301 receives a PMT including information of the selected virtual channel (S3502). The demultiplexer 2301 then parses the PMT to extract information such as a program number (S3503). Then, the demultiplexer 2301 extracts information such as stream_type and elementary_PID from the PMT (S3504).

The demultiplexer then determines whether or not the stream_type field value is “0xD2” (S3505). For example, if the value of the stream_type field is “0xD2”, the stream_type field indicates that the stream is IPTV scalable video data. In this case, the scalable_video_descriptor( ) is transmitted by incorporating into the second loop of the PMT.

Accordingly, if it is determined at step S3505 that the stream_type field value is “0xD2”, the demultiplexer 2301 parses the scalable_video_descriptor( ) (S3506) and extracts information such as scalability_type, layer_id, base_layer_id field, frame rate information (for example, frame_rate_code, frame_rate_num, frame_rate_denom), and profile information (for example, profile_idc, constraint_set0_flag˜constraint_set3_flag, level_idc) from the scalable_video_descriptor( ) (S3507).

The demultiplexer 2301 then determines whether or not the layer_id field value is “0x0” (S3508). For example, if the layer_id field value is “0x0”, this indicates that the corresponding video stream is of the base layer.

Accordingly, if it is determined at step S3508 that the layer_id field value is “0x0”, the demultiplexer 2301 outputs the scalable video data of the base layer to the video decoder 2302 (S3509). Then, the demultiplexer 2301 determines whether or not the video decoder 2302 supports an enhancement layer (S3510). The demultiplexer 2301 returns to the above step S3505 if it is determined at step S3510 that the video decoder 2302 supports an enhancement layer and proceeds to step S3515 if it is determined that the video decoder 2302 does not support an enhancement layer. At step S3515, video decoding is performed on a video stream of only the base layer through the video decoder 2302 to provide an IPTV service to the user.

On the other hand, if it is determined at the above step S3508 that the layer_id field value is not “0x0”, the demultiplexer 2301 proceeds to step S3511 since the layer_id field value indicates that the corresponding video stream is of an enhancement layer. At step S3511, the demultiplexer 2301 determines whether or not the video decoder 2302 supports scalable video data of the enhancement layer. If it is determined that the video decoder 2302 supports scalable video data of the enhancement layer, the demultiplexer 2301 outputs the scalable video data of the enhancement layer to the video decoder 2302 and returns to step S3504 (S3512). For example, if it is determined at step S3511 that the receiving system supports the first enhancement layer, the demultiplexer 2301 outputs scalable video data of the first enhancement layer to the video decoder 2302 at step S3512.

If it is determined at step S3511 that the video decoder 2302 does not support the enhancement layer, the demultiplexer 2301 discards scalable video data (specifically, packets with the corresponding PID) of the enhancement layer without outputting the scalable video data to the video decoder 2302. Here, the demultiplexer 2301 also discards scalable video data of any enhancement layer higher than the enhancement layer without outputting the scalable video data to the video decoder 2302. For example, if it is determined at step S3511 that the receiving system does not support the first enhancement layer, the demultiplexer 2301 discards scalable video data of the first and second enhancement layers without outputting the scalable video data to the video decoder 2302 at step S3513.

If it is determined at the above step S3505 that the stream_type field value is not “0xD2” (i.e., the corresponding stream is not IPTV scalable video data), the demultiplexer 2301 proceeds to step S3514. At step S3514, the demultiplexer 2301 outputs the received stream to the corresponding decoder. Here, if another stream remains, the demultiplexer 2301 returns to step S3504, otherwise it proceeds to step S3515.

For example, if the video decoder 2302 supports up to the first enhancement layer, video decoding is performed on scalable video data of the base layer and the first enhancement layer to provide an IPTV service to the user at the above step S3515.

FIG. 36 is a block diagram of an IPTV receiver according to an embodiment of the present invention.

Referring to FIG. 36, an IPTV receiver according to the present invention includes a network interface unit transmitting/receiving an IP packet by connecting the broadcast receiver to a service provider via a network, a display unit outputting a broadcast signal received by the network interface unit, and a control unit controlling remaining storage space information to be sent to the service provider, the control unit controlling an adaptive broadcast signal based on the sent remaining storage space information to be displayed or stored.

Detailed configuration of the broadcast receiver is explained as follows. First of all, the receiver includes a network interface unit 3602, an IP manager 3604, a RTP/RTCP manager 3605, a control unit 3606, a service manager 3608, a service information decoder 3610, a service information (SI) database 3612, a service discovery & selection (SD&S) manager 3614, a RTSP manager 3616, a demultiplexer 3618, an audio/video decoder 3620, a display unit 3622, a first storage unit 3624, a system manager 3626, a storage control unit 3628 and a second storage unit 3630.

The network interface unit 3602 receives packets received from a network and transmits packets from the receiver via the network. In particular, the network interface unit 3602 receives an adaptive broadcast signal of the present invention from a service provider according to the present invention via the network.

The IP manager 3604 manages the packet delivery from a source to a destination for a packet received by the receiver and a packet transmitted by the receiver. The IP manager 3604 sorts the received packets to correspond to an appropriate protocol and then outputs the sorted packets to the RTSP manager 3616 and the SD&S manager 3614. For instance, the IP manager 3604 is able to deliver the packet containing remaining storage space information to the service provider.

The control unit 3606 controls an application and controls overall operations of the receiver according to a user's input signal by controlling the user interface (not shown in the drawing). The control unit 3606 provides a graphic user interface (GUI) for user using OSD (on screen display) and the like. The control unit 3606 receives an input signal from a user and then performs a receiver operation according to the input. For instance, in case of receiving a key input for a channel selection from a user, the control unit 3606 transfers the channel selection input signal to the channel manager. In case of receiving a key input for a specific service selection included in an available service information list from a user, the control unit 3606 transfers the service selection input signal to the service manager 3608.

The control unit 3606 controls the remaining storage space information of the second storage unit 3630 to be transferred to the service provider. The control unit 3606 controls an adaptive broadcast signal, which is based on the transferred remaining storage space information, to be displayed.

The service manager 3608 generates a channel map by storing received channel information. The service manager 3608 selects a channel or a service according to a key input received from the control unit 3606 and controls the SD&S manager 3614.

The service manager 3608 receives service information of a channel from the service information decoder 3610 and then performs audio/video PID (packet identifier) setting of the selected channel and the like on the demultiplexing unit (demultiplexer) 3618.

The service information decoder 3610 decodes such service information as PSI (program specific information) and the like. In particular, the service information 3610 receives the demultiplexed PSI table, PSIP (program and service information protocol) table, DVB-SI (service information) table and the like from the demultiplexer 3618 and then decodes the received tables.

The service information decoder 3610 generates a database relevant to service information by decoding the received service information tables and then stores the database relevant to the service information in the service information database 3612.

The SD&S manager 3614 provides information required for selecting a service provider, who provides a service, and information required for receiving a service. In particular, the SD&S manager 3614 receives a service discovery record, parses the received service discovery record, and then extracts information required for selecting a service provider and information required for receiving a service. In case of receiving a signal for a channel selection from the control unit 3606, the SD&S manager 3614 discovers a service provider using the information.

The RTSP manager 3616 is responsible for selection and control of a service. For instance, if a user selects a live broadcasting service according to a conventional broadcasting system, the RTSP manager 3616 performs the service selection and control using IGMP or RTSP. If a user selects such a service as VOD (video on demand), the RTSP manager 3616 performs the service selection and control using RTSP. In this case, the RTSP (real-time streaming protocol) can provide a trick mode for real-time streaming.

The service relevant packet received via the network interface unit 3602 and the IP manager 3604 is transferred to the RTP/RTCP manager 3605.

The RTP/RTCP manager 3605 is responsible for the control of received service data.

For instance, in case of controlling real-time streaming data, RTP/RTCP (real-time transport protocol/RTP control protocol) is used. In case that the real-time streaming data is transported using the RTP, the RTP/RTCP manager 3605 parses the received data packet according to the RTP and then transfers the parsed packet to the demultiplexer 3618. The RTP/RTCP manager 3605 feeds back the network reception information to a sever that provides a service using the RTCP. In doing so, the real-time streaming data is directly delivered by being encapsulated with UDP without RTP.

The demultiplexer 3618 demultiplexes the received packet into audio data, video data, PSI (program specific information) data and the like and then transfers them to the video/audio decoder 3620 and the service information decoder 3610, respectively. Moreover, the demultiplexer 3618 transfers the demultiplexed data to the storage control unit 3628 to enable the demultiplexed data to be recorded under the control of the controller 3608.

The audio/video decoder 3620 decodes the audio and video data received from the demultiplexer 3618. The audio/video data decoded by the audio/video decoder 3620 are provided to a user via the display unit 3622.

The first storage unit 3624 stores setup data of system and the like. In this case, the first storage unit 3624 can include a non-volatile memory (non-volatile RAM: NVRAM), a flash memory or the like.

The system manager 3626 controls overall operations of the receiver system via power.

The storage control unit 3628 controls the recording of the data outputted from the demultiplexer 3618. In particular, the storage control unit 3628 stores the data outputted from the demultiplexer 3618 in the second storage unit 3630. The storage control unit 3628 manages a storage space of the second storage unit 3630. The storage control unit 3628 calculates remaining storage space information and is then able to provide the calculated information to the control unit 3606.

The second storage unit 3630 stores the received content under the control of the storage control unit 3628. In particular, the second storage unit 3630 stores the data outputted from the demultiplexer 3618 under the control of the storage control unit 3628. In this case, the second storage unit 3630 can include such a non-volatile memory as HDD and the like. Moreover, a content having a different bitrate per region can be recorded in the second storage unit 3632 according to a remaining storage space capacity of the second storage unit 3630.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An internet protocol television (IPTV) receiving system comprising:
a signal receiving unit for receiving an IPTV signal including respective scalable video streams for IPTV services of a plurality of layers including a base layer and at least one enhancement layer, the respective scalable video streams of the plurality of layers having different identifiers and program table information for the scalable video streams;
a demodulating unit for demodulating the respective scalable video streams of the plurality of layers and the program table information of the received IPTV signal;
a demultiplexer for identifying and outputting the demodulated video stream of the base layer with reference to the demodulated program table information and identifying and outputting the demodulated video stream of at least one enhancement layer; and
a decoder for performing video decoding on a video stream of at least one layer identified and outputted by the demultiplexer.

2. The receiving system according to claim 1, wherein the demultiplexer determines whether or not each received video stream is a scalable video stream for IPTV services with reference to information included in a Virtual Channel Table (VCT) among the program table information and identifies a video stream of the base layer with reference to an identifier of each video stream that has been determined to be a scalable video stream for IPTV services and outputs the identified video stream of the base layer for video decoding.

3. The receiving system according to claim 2, wherein the demultiplexer identifies a video stream of at least one enhancement layer according to whether or not video decoding of the video stream of the enhancement layer is possible and outputs the identified video stream for video decoding.

4. The receiving system according to claim 2, wherein the VCT includes at least one of information for determining whether or not the received video stream is a scalable video stream for IPTV services and layer information of the video stream.

5. The receiving system according to claim 1, wherein the demultiplexer determines whether or not each received video stream is a scalable video stream for IPTV services with reference to information included in a Program Map Table (PMT) among the program table information and identifies a video stream of the base layer with reference to an identifier of each video stream that has been determined to be a scalable video stream for IPTV services and outputs the identified video stream of the base layer for video decoding.

6. The receiving system according to claim 5, wherein the demultiplexer identifies a video stream of at least one enhancement layer according to whether or not video decoding of the video stream of the enhancement layer is possible and outputs the identified video stream for video decoding.

7. The receiving system according to claim 5, wherein the PMT includes at least one of information for determining whether or not the received video stream is a scalable video stream for IPTV services and layer information of the video stream.

8. A data processing method for an internet protocol television (IPTV) receiving system, the method comprising:
receiving an IPTV signal including respective scalable video streams for IPTV services of a plurality of layers including a base layer and at least one enhancement layer, the respective scalable video streams of the plurality of layers having different identifiers and program table information for the scalable video streams;
demodulating the respective scalable video streams of the plurality of layers and the program table information of the received IPTV signal;
identifying and outputting a demodulated video stream of the base layer with reference to the demodulated program table information and identifying and outputting a demodulated video stream of at least one enhancement layer; and
performing video decoding on the identified and output video stream of at least one layer.

9. The data processing method according to claim 8, wherein the demultiplexing step includes determining whether or not each received video stream is a scalable video stream for IPTV services with reference to information included in a Virtual Channel Table (VCT) among the program table information and identifying a video stream of each layer with reference to an identifier of each video stream that has been determined to be a scalable video stream for IPTV services and outputting the identified video stream for video decoding.

10. The data processing method according to claim 8, wherein the demultiplexing step includes determining whether or not each received video stream is a scalable video stream for IPTV services with reference to information included in a Program Map Table (PMT) among the program table information and identifying a video stream of each layer with reference to an identifier of each video stream that has been determined to be a scalable video stream for IPTV services and outputting the identified video stream for video decoding.
